(19) United States
(12) Patent Application Publication
(10) Pub. No.: US 2022/0350147 A1
(43) Pub. Date: Nov. 3, 2022

(54) CONFORMABLE ELECTRODES WITH LOW CONSPICUITY

(71) Applicant: META PLATFORMS TECHNOLOGIES, LLC, Menlo Park, CA (US)

(72) Inventors: Andrew John Ouderkirk, Kirkland, WA (US); Liliana Ruiz Diaz, Bothell, WA (US)

(21) Appl. No.: 17/704,458

(22) Filed: Mar. 25, 2022

Related U.S. Application Data
(60) Provisional application No. 63/181,370, filed on Apr. 29, 2021.

(51) Int. Cl. G02B 27/01; G02B 27/00; G02B 26/00

(52) U.S. Cl. CPC G02B 27/0172; G02B 27/0093; G02B 26/004; G02B 2027/0178

(57) ABSTRACT

An example apparatus may include a display and an optical configuration configured to provide an image of the display. The optical configuration may include a lens having a lens surface that supports at least one serpentine electrode. The at least one serpentine electrode may be in electrical communication with an electrical component such as an electrooptical component (e.g., including at least one of a laser, light-emitting diode, photodiode, or image sensor) or an electroactive component that may show one or more dimensional changes under application of an electric field. An example apparatus may also include a controller in electrical communication with the electrical component through the at least one serpentine electrode. In some examples, the serpentine electrode may have an approximately sinusoidal shape. Other devices, methods, systems, and computer-readable media are also disclosed.

### CROSS REFERENCE TO RELATED APPLICATION

This application claims the benefit of U.S. Provisional Application No. 63/181,370 filed Apr. 29, 2021, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 shows an example apparatus that may include at least one serpentine electrode in accordance with various embodiments.

FIG. 2 is an illustration of an example device having a substrate supporting one or more serpentine electrodes in accordance with various embodiments.

FIG. 3 shows further example serpentine electrodes in accordance with various embodiments.

FIG. 4 shows an example device including serpentine electrodes in which the electrodes have a predominantly radial configuration in accordance with various embodiments.

FIG. 5 is an illustration of an exemplary adjustable fluid lens that may be used in connection with embodiments of this disclosure.

FIGS. 6A-6D show example serpentine electrodes in accordance with various embodiments.

FIG. 7 shows an electrical component mounted to a substrate supporting electrodes in accordance with various embodiments.

FIG. 8 shows electrodes attached to a substrate using an attachment layer in accordance with various embodiments.

FIG. 9 shows an electroconstriction element located between a pair of electrodes in accordance with various embodiments.

FIG. 10 shows example neighboring serpentine electrodes without spatial phase relationship in accordance with various embodiments.

FIG. 11 shows example neighboring serpentine electrodes with an electrical component located between neighboring portions in accordance with various embodiments.

FIG. 12 shows an example apparatus including a controller in accordance with various embodiments.

FIG. 13 shows a further example apparatus including a controller in accordance with various embodiments.

FIG. 14 shows an optical configuration in accordance with various embodiments.

FIGS. 15 and 16 illustrate example methods of operating an apparatus in accordance with various embodiments.

FIG. 17 shows an example method of fabricating an apparatus in accordance with various embodiments.

FIG. 18 is an illustration of exemplary augmented-reality glasses that may be used in connection with embodiments of this disclosure.

FIG. 19 is an illustration of an exemplary virtual-reality headset that may be used in connection with embodiments of this disclosure.

FIG. 20 is an illustration of an exemplary system that incorporates an eye tracker subsystem capable of tracking a user's eye(s) in accordance with various embodiments.

FIGS. 21A and 21B show a more detailed illustration of various aspects of the eye tracker illustrated in FIG. 20 in accordance with various embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and are described in detail herein. However, the exemplary embodiments described herein are not intended to be limited to the particular forms disclosed. Rather, the present disclosure may include all modifications, equivalents, and alternatives falling within the scope of the appended claims.

### DETAILED DESCRIPTION OF EXEMPLARY EMBODIMENTS

The present disclosure is generally directed to optical configurations, devices including optical configurations, and associated methods. As is explained in greater detail below, embodiments of the present disclosure may include a lens suitable for virtual and/or augmented reality systems supporting one or more serpentine electrodes.

In-field illumination, imaging, or both are typically useful for eye tracking with near-eye and wide field-of-view (FOV) optics. Unfortunately, forming circuits on curved surfaces can be challenging. Accordingly, the present disclosure provides a method for forming a circuit pattern, such as one or more electrodes, on a flat surface such that the circuit can then be conformed to a curved profile, in some examples including a complex curve. Examples include serpentine electrodes that may be located on a lens surface, such as a convex, concave, or planar lens surface.

In some examples, a method may include forming one or more serpentine electrodes (e.g., as part of an electrical circuit pattern) on a substrate, where the substrate may be at least generally planar during formation of the electrodes. Electrodes may be deposited using any suitable technique. The substrate may then be distorted into a curved profile, for example, as part of a lens. The circuit may conform to a complex curve, and at least one serpentine electrode may conform to the curved surface profile of the substrate. For example, at least one serpentine electrode may be formed on (e.g., supported by) a planar elastic membrane and any suitable electrical components may be located in electrical communication with a serpentine electrode. An adjustable lens may be fabricated including the elastic membrane, the elastic membrane may adopt a curved profile during lens operation, and the serpentine electrode(s) and associated electrical components may then be a component of an adjustable lens where the elastic membrane may adopt a curved profile. This approach allows electrodes and electrical components to be supported within the aperture of an adjustable lens.

An example apparatus may include a display and an optical configuration. The optical configuration may be arranged to form an image of the display at an eyebox, a location within the apparatus where a display image may be viewed by a user. The apparatus may be or include a wearable apparatus, such as a head-mounted device, and the display image may be viewed by the user at the eyebox when the user wears the apparatus.

In some examples, a substrate such as a lens surface may support at least one serpentine electrode. The serpentine electrode may be in electrical communication with at least one electrical component, such as a light-emitting diode, a laser, or an optical sensor. In some examples, the substrate may be deformable and may include, for example, the adjustable surface profile of an adjustable lens. In some examples, a lens surface may support a first serpentine electrode and an electrical component having a first terminal in electrical communication with the first serpentine electrode. The electrical component may have a second terminal in electrical communication with a second electrode, such as a second serpentine electrode.

In some examples, the substrate may be adjustable between a first configuration having a first curved profile and a second configuration having a second curved profile. In some examples, the first and/or second curved profile may have an average radius of curvature of less than about 1000 mm (e.g., less than about 500 mm, less than about 100 mm, or less than about 50 mm). In some examples, the first and/or second curved profile may conform to a compound curve. In some examples, the substrate may include an elastomer layer and may include, for example, an elastic membrane. In some examples, the substrate may be a component of a lens (e.g., an adjustable lens) or another optical component such as a polarizer (e.g., a reflective polarizer and/or a multilayer polarizer), window, optical retarder, diffractive element, mirror, or other optical component.

In some examples, a method for forming a compound curved refractor or reflector may include forming a serpentine electrode on a substrate, such as a polymer substrate. In some examples, an electrical component may be located on the substrate or otherwise supported by the substrate and may be in electrical communication with at least one serpentine electrode. In some examples, the substrate may be modified to provide a curved surface profile, for example, including a compound curve. In some examples, modification of the substrate may include at least one of molding, heating, application of an electric field (e.g., to an electroactive element), or application of a force to induce deformation such as bending, stretching, or the like. A serpentine electrode may include at least a portion having a sinusoidal form.

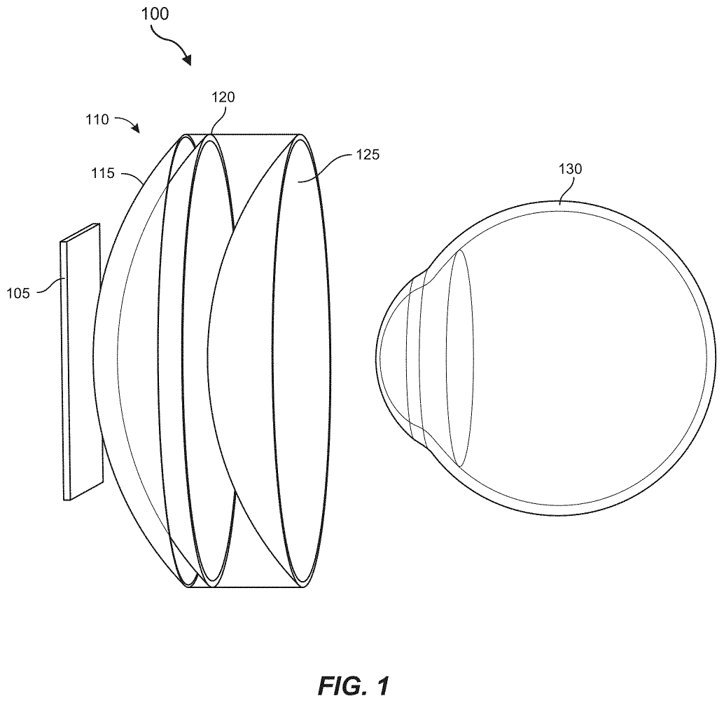

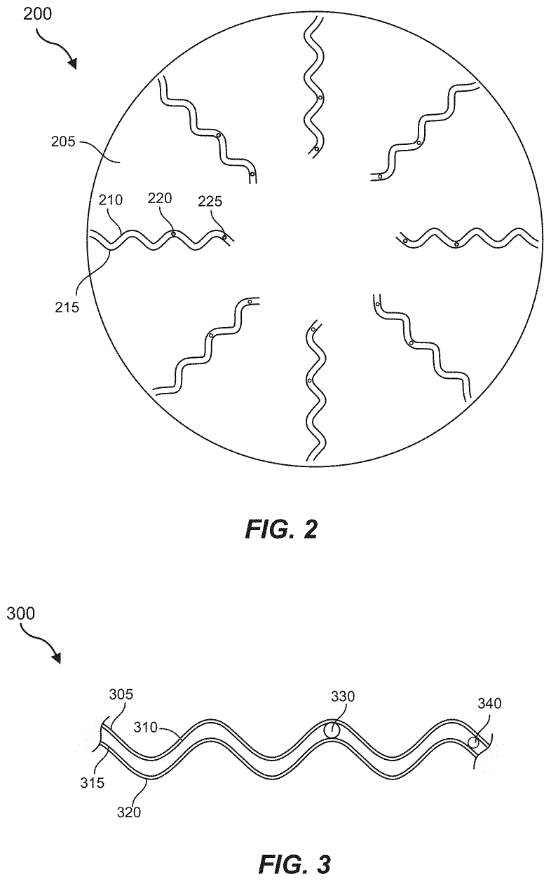

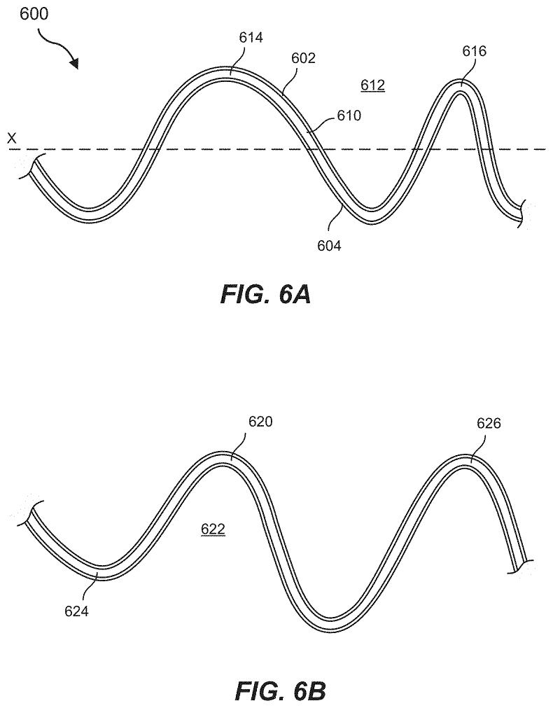

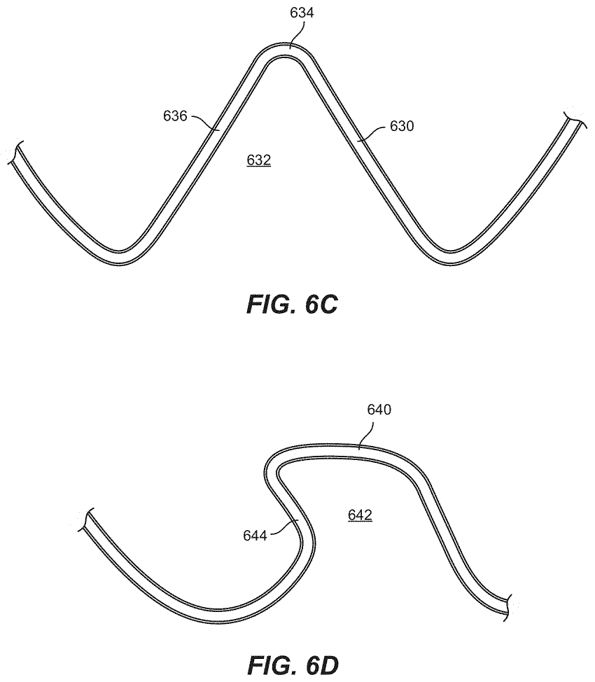

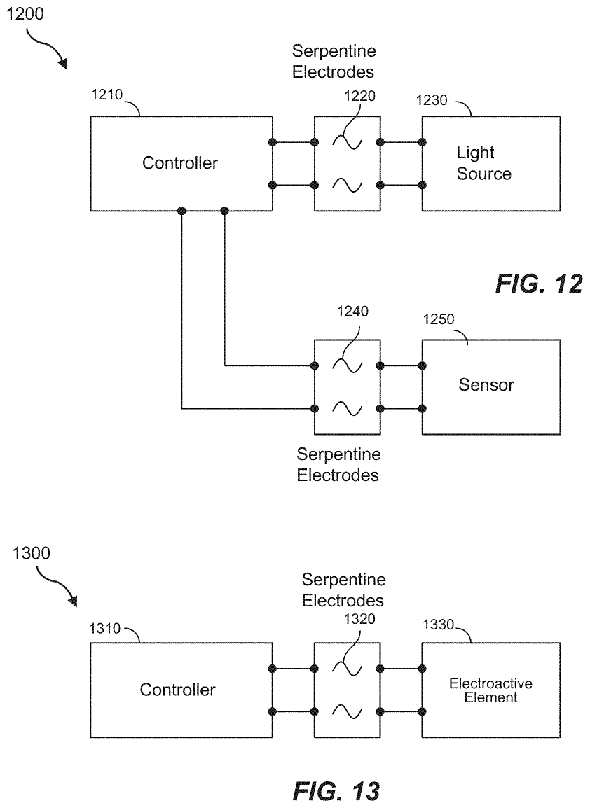

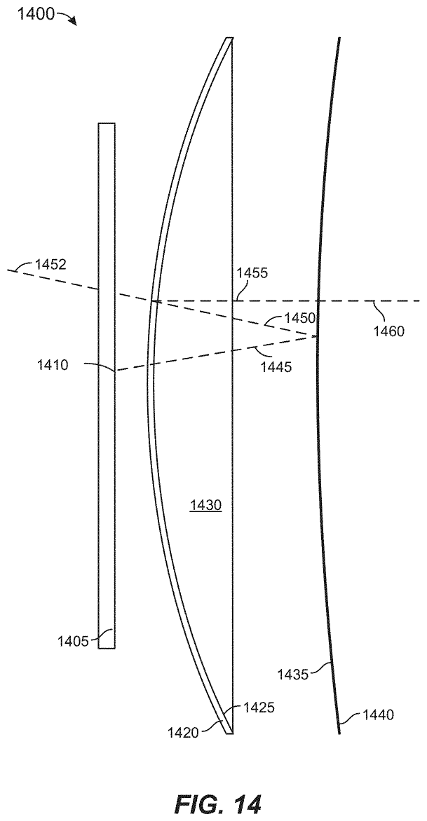

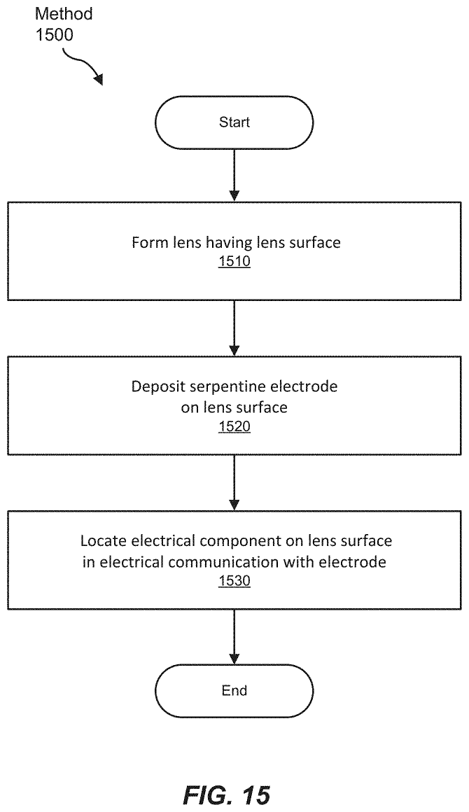

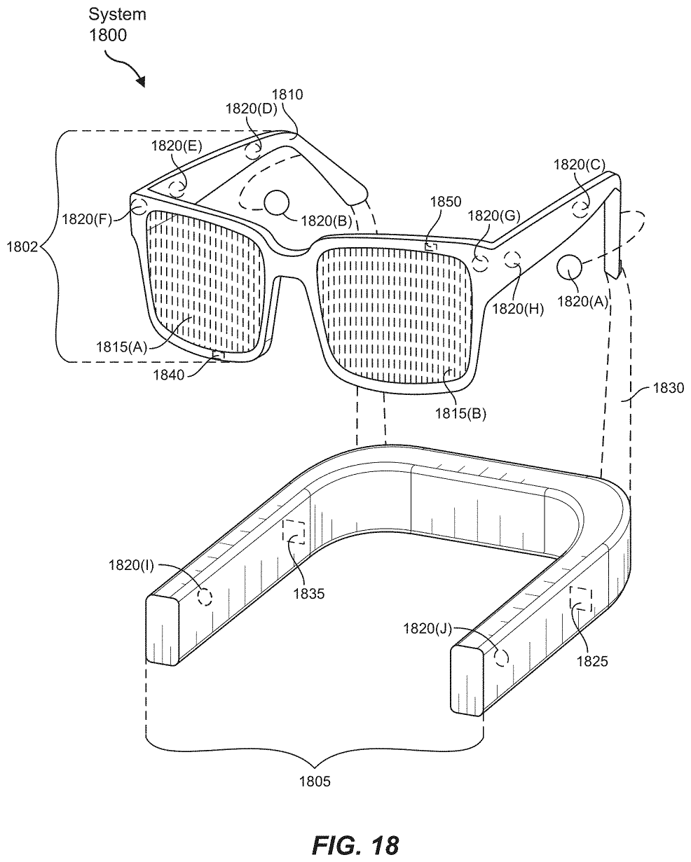

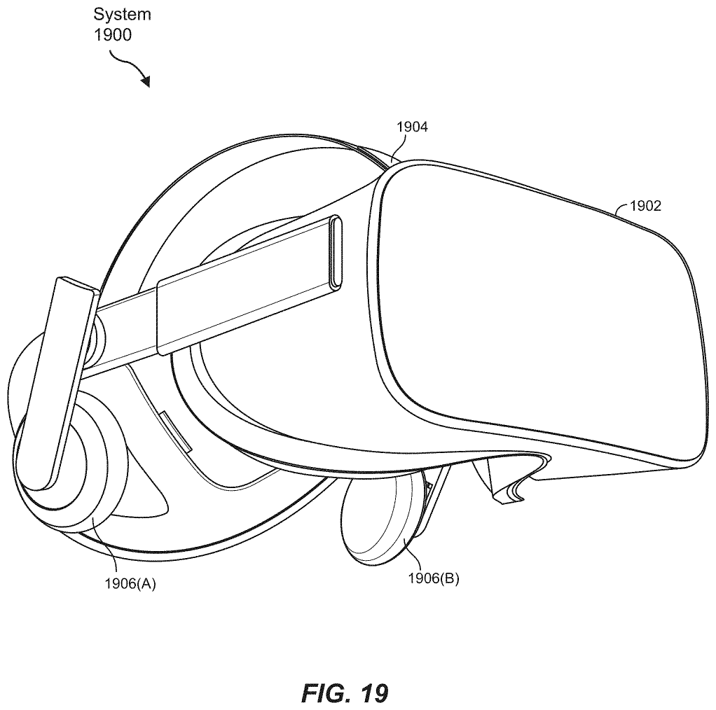

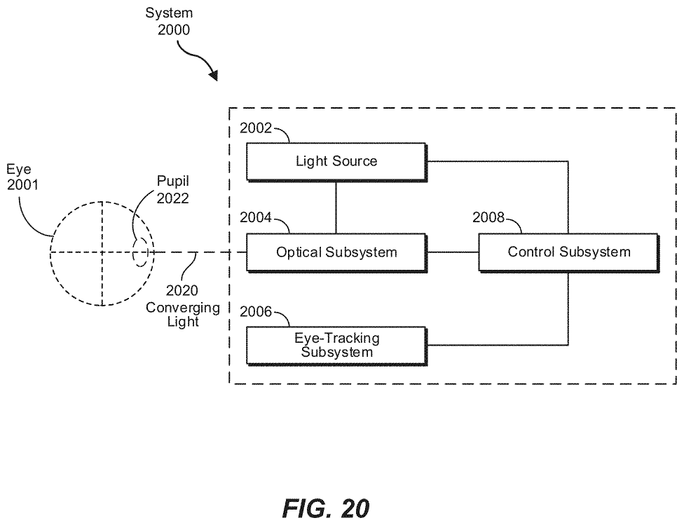

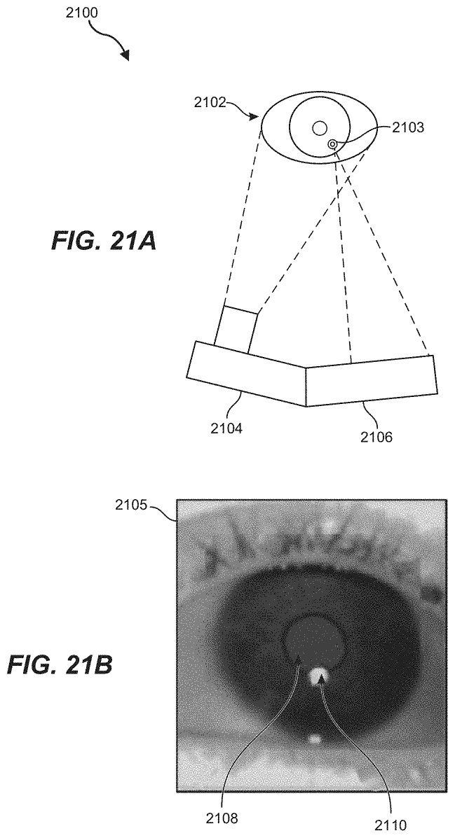

The following provides, with reference to FIGS. 1-21, detailed descriptions of example embodiments. FIG. 1 shows an example apparatus that may include at least one serpentine electrode in accordance with various embodiments. FIGS. 2-4 show example arrangements of serpentine electrodes that may be located on a substrate such as a lens surface. FIG. 5 shows how serpentine electrodes may be located on an elastic membrane of an adjustable lens. FIGS. 6A-11 show example arrangements of serpentine electrodes and electrical components. FIGS. 12 and 13 illustrate example apparatus configurations including a controller. FIG. 14 shows a further optical configuration in accordance with various embodiments. FIGS. 15-17 illustrate example methods of apparatus operation and fabrication. FIGS. 18 and 19 show exemplary augmented-reality and virtual-reality headsets. FIGS. 20-21B show example eye-tracking subsystems.

Improvements in the optical configuration may be desirable, such as reduced weight and power consumption in device applications. In some examples, the lens may include a Fresnel lens. In some examples, a lens assembly may include at least one of each of a polarized reflector, beamsplitter, serpentine electrode, or electrical component supported by a lens surface. In some examples, a beamsplitter may be replaced by a polarized reflector to reduced losses associated with the beamsplitter.

FIG. 1 shows an example apparatus that may include at least one serpentine electrode. The apparatus may include a display and a folded optical configuration. The example apparatus 100 may include a display 105 and an optical configuration 110. In some examples, the optical configuration may have a folded optical arrangement in which the direction of light propagation may be reversed on one or more occasions. The display 105 may emit polarized light, for example, linearly or circularly polarized light. In some examples, light from the display 105 is incident on the optical configuration 110 and the optical configuration is configured to provide an image of the display to the eye 130 of a user, for example, when the device is worn or otherwise engaged with by the user. The optical configuration 110 may include a beamsplitter 115 (e.g., that may include a partially transparent reflector), an optical retarder 120 (e.g., a quarter wave retarder), and a reflective polarizer 125 (e.g., a linear reflective polarizer). In some examples, a reflective polarizer may be reflective to one handedness of circularly polarized light and transmissive to a second handedness of circularly polarized light. In some examples, the optical retarder 120 may be omitted.

Optical components, such as a lens, may have a curved surface that may be defined by one or more compound curves. In some examples, optical components may have other shapes and may have one or more planar surfaces. In some examples, it may be useful to mount electrical components within the aperture of the lens, through which an image may be formed. Electrical components may include electrooptical components such as lasers, light-emitting diodes, sensors, or the light. Electrical components may be relatively small, for example, having an effective cross-sectional dimension (e.g., the diameter of a circular profile, diameter, or analogous dimension) of approximately equal to or less than 1 mm, such approximately equal to or as less than 500 microns, for example, approximately equal to or less than 200 microns, and in some examples, approximately equal to or less than 100 microns. However, electrical connection to an electrical component may present issues. For example, a linear electrode may be visually discernable and may be distracting to a user of the apparatus. Serpentine electrodes as described herein were found to be less visually discernable for a particular track width or overall conductivity. In some examples, the distance between an electrical component supported by a lens and a corresponding electrical contact (e.g., at the edge of the lens) may change if the focal length of the lens is adjusted, for example, by modifying the curvature of the surface profile. Lens profile adjustments may result in failure of a conventional electrode, for example, due to excessive tension, buckling, or other failure mode. However, a serpentine electrode may allow greater dimensional expansion along the general direction of the serpentine electrode (discussed further below).

FIG. 2 shows a portion of an apparatus 200 including a substrate 205 supporting one or more electrodes arranged on the substrate 205. In this example, the apparatus 200 includes a first electrode 210 and a second electrode 215, and the first electrode 210 and the second electrodes 215 may each be serpentine electrodes. In some examples, a serpentine electrode may be in electrical communication with one or more electrical components (e.g., electrical components 220 or 225 or electrical contacts thereto), such as a light source, sensor (e.g., a photodiode or image sensor), other electrical component such as an electroactive element, or to electrical contacts (e.g., electrodes) for any other electrical (e.g., electrooptical) component. In some examples, a serpentine electrode may allow control of an optical retarder (e.g., the optical retarder 120 discussed above in relation to FIG. 1) or a reflective polarizer e.g., the reflective polarizer 125 discussed above in relation to FIG. 1), or any suitable electrooptical layer or multilayer structure including at least one electrooptical layer. An electrooptical layer may include a layer having an effective optical property for incident light (e.g., refractive index) that may be electrically controlled. An example electrooptical layer may include, for example, a liquid crystal layer or other electrooptical material. The substrate 205 may include a lens surface. In some examples, the substrate may have a planar configuration during electrode formation and the substrate may then be conformed to a curved surface, for example, for a lens application.

In some cases, a serpentine electrode may be configured to allow the substrate supporting the serpentine electrode to be stretched to a particular degree without exceeding the failure strain of the electrode. For example, a serpentine electrode may be deposited on a generally planar surface of a substrate, and the substrate may then be deformed into a generally curved surface (e.g., a convex or concave surface). In some examples, serpentine electrodes may be deposited on a surface having adjustable curvature, for example, when the surface is in a generally planar state or other curved state.

In some examples, an electrode may include an electrode material, and the electrode material may include a metal such as copper, silver, gold, or other suitable metal (including alloys). In some examples, a serpentine electrode may include one or more electrode materials, for example, in a multilayered or otherwise patterned structure. In some examples, an electrode material may include one or more of a metal (e.g., silver, copper, gold, other transition metal, aluminum, or other metal), a transparent conductive oxide (TCO) such as indium tin oxide (ITO) or indium gallium zinc oxide (IGZO), an electrically conductive polymer, a doped semiconductor, electrically conductive fibers (e.g., carbon fibers), graphene, electrically conductive nanowires (e.g., metal nanowires such as silver nanowires, copper nanowires, or gold nanowires), electrically conductive nanotubes (e.g., carbon nanotubes), or other electrically conductive material.

In some examples, a serpentine electrode may extend along a general direction, for example, an average direction of the serpentine electrode. An example serpentine electrode may have a path (or shape) defined by extension along a general direction combined with a spatially varying lateral deviation (e.g., a deviation perpendicular to the local general direction). For example, a serpentine electrode extending over a lens surface between a peripheral electrical contact and an electrical component may have a general direction that extends along a path between the electrical contact and the electrical component, and lateral deviations that have a component perpendicular to the general direction. In some examples, the serpentine electrode may have a spatially oscillatory form, in which the lateral deviations about the general path may include a periodic or non-periodic spatial oscillation. In some examples, a serpentine electrode may include a spatially oscillatory deviation about the path of a linear or smoothly curved electrode that the serpentine electrode may advantageously replace.

In some examples, a serpentine electrode may have a generally sinusoidal shape, and/or may include at least one electrode portion having a generally sinusoidal shape. For example, a serpentine electrode may have a path including a lateral deviation that may be described by D=A sin(b.d), where A may represent a sinusoid amplitude (or analogous parameter), d may represent a distance parameter related to distance along a general path (e.g., along a linear or smoothly curved path), and b may be a parameter related to spatial frequency. The amplitude A may be approximately equal to or less than 1 mm, for example, approximately equal to or less than 500 microns, and in some examples, approximately equal to or less than 200 microns. The repeat distance (spatial wavelength) of a sinusoidal serpentine electrode path may be approximately equal to or less than 2 mm, for example, approximately equal to or less than 1 mm, for example, approximately equal to or less than 500 microns, for example, approximately equal to or less than 300 microns.

Applications of serpentine electrodes as described herein may include use in an optical configuration of a wearable device (e.g., a head-mounted device). In some examples, a serpentine electrode as described herein may be supported on a lens surface (or, e.g., by another optical element) within an optical configuration configured to form an image of a display viewable by a user when the user wears the wearable device. Other example applications may include the electrical communication of signals to or from an electrical component. An electrical component may include an electrooptical component such as a light source or sensor, or an electroactive component (such as one or more electrostrictive layers) supported by the surface of an optical component such as a lens. In some examples, an electroactive element may include an electroactive polymer, such as an electrostrictive polymer. Example electrostrictive polymers include ferroelectric polymers such as various halogenated vinylidene based polymers and copolymers, including poly(vinylidene difluoride) (PVDF), its analogs, derivatives, and copolymers.

In some examples, a head-mounted device may use in-field illumination of the eye for eye tracking (e.g., gaze direction detection), and examples may provide electrical connections having low social and user visibility. In some examples, a serpentine electrode may include a transparent electrical conductor. A transparent serpentine electrode may have visually discernable edges due to refractive index differences across interfaces. In some examples, a generally transparent material may have a visually discernable tint due to some absorption. However, a serpentine electrode may be less readily visually discernable than a linear or smoothly curved electrode.

In some examples, the shape, width, or other geometric features of the electrode may be optimized using finite element analysis, for example, including a mechanical model of the electrodes and substrate.

In some examples, a serpentine electrode may be in electrical communication with one or more electrical components. Examples of electrical components may include optical devices such as light-emitting diodes (LEDs), lasers such as vertical cavity surface emitting lasers (VCSELs), laser diodes, photosensors, and combinations thereof. Electrical components may also be integrated circuits or other electrical components to convert power, provide analog to digital conversion, digital to analog conversion, or to transmit information either to or from parts of the components.

In some examples, the substrate may be transparent. In some examples, the substrate may include a polymer such as, for example, an acrylate polymer (e.g., polymethylmethacrylate, PMMA), a polycarbonate (PC), polyethylterephthalate (PET), PEN, COC, COP, polystyrene (PS), and the like. In some examples, the substrate may include an elastomer, for example, silicone, urethane, or an acrylate polymer. In some examples, the substrate may include an elastic membrane. The substrate may include a composite film such as a multilayer optical film, and may include a reflective layer (e.g., a mirror) and/or a reflective polarizer. In some examples, a substrate may include at least one or a combinations of a polymer such as an elastomer or a composite film. In some examples, a substrate may include a plastic layer. For example, the substrate may include a multilayer optical film reflective polarizer. In some examples, the substrate may include an elastic material such as an acrylate, on which at least one serpentine electrode is placed. In some examples, a serpentine electrode may be formed by a printed circuit process, for example, by etching or other patterning of an electrically conductive layer supported by the substrate. In some examples, the substrate may include a transparent substrate. In some examples, a substrate may include an elastic substrate, such as an elastic transparent substrate.

An example substrate may be a material that may be either elastically or plastically deformed to a curved profile, such as a profile including a compound curve. The curved profile may have an average radius of curvature of less than about 1000 mm, such as less than about 500 mm, less than about 100 mm, or less than about 50 mm.

Distorting a substrate (e.g., stretching a substrate, e.g., into a compound curve) may cause localized distortions of elastomer components. Optical effects may be mitigated by applying an approximately refractive index matched coating to encapsulate the circuit and devices. The coating may be applied either before or after the substrate is formed to a compound curve. In some examples, the coating may be termed a filler layer, and may include an optically transparent polymer.

FIG. 3 further illustrates serpentine electrodes, such as those shown in FIG. 2. Apparatus 300 may include first pair of serpentine electrodes (including first electrode 305 and second electrode 310), second pair of serpentine electrodes (including third electrode 315 and fourth electrode 320), and electrical components 330 and 340. For example, electrical components 330 and 340 may include light sources that may be energized by an electrical signal provided through the respective serpentine electrodes by a controller (not shown). In some examples, an electrical component may include a light source (e.g., a laser or LED) that may be a component of an eye tracker), a sensor (e.g., a photodiode, image sensor, or other optical sensor), an electroactive component (e.g., an electrostrictive element), or other electrical component.

In some examples, an improved eye tracking may include electrical components (e.g., light sources and/or sensors) that are supported by a lens (e.g., located on the surface of a lens) within the field of view of a user. In some examples, eye tracking components may be located on the surface of a lens of an AR/VR system, for example, located on the surface of an eyeglass lens or other lens. Electrical components located on the lens may be located closer to the center of the eye than locations around the periphery of the lens, such as on the frame or other support structure. Electrodes to any electrical component within the field of view of the user may be visually distracting. However, the use of serpentine electrodes, such as those as described herein, may greatly reduce user perception of any such electrodes.

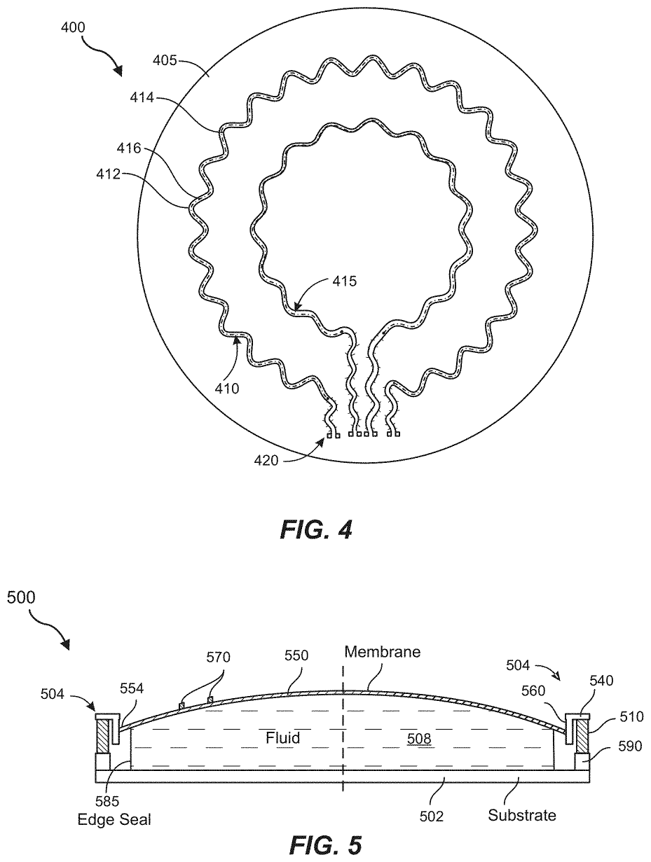

FIG. 4 shows a further illustration of an apparatus 400 including serpentine electrodes, including first electrode pair 410 (including first electrode 412 and second electrode 414) and second electrode pair 415. The dashed line 416 may represent an average trajectory of a serpentine pair of electrodes. In some examples, at least one electrical component may be powered and/or transmit or receive, or both, data through the first electrode pair 410 (including first electrode 412 and second electrode 414), or second electrode pair 415. Electrical contacts 420 allow electrical communication with at least one electrical component. Electrical communication may include power (e.g., to energize an electrical component), data transmission to an electrical component, and/or data reception from an electrical component.

In some examples, the electrodes may be formed on a substrate having a center (such as a circular substrate), and the electrodes may extend away from or towards the center of the substrate (e.g., along a radial direction of a circular substrate). In some examples, the electrodes may have a generally circular path about the center of the substrate. In some examples, electrodes may have a generally radial portion extending to an electrical contact and a generally circular portion disposed around a circular substrate (e.g., as illustrated in FIG. 4). In some examples, a substrate may have any shape and electrodes may include a first portion in contact with an electrical contact near the periphery of the substrate, a second portion, for example, extending around the periphery, around the center, or otherwise forming a generally loop-type pattern, and a third portion to a second contact near the periphery of the substrate. In some examples, an electrode or pair of electrodes may extend across a substrate in any suitable manner, for example, to allow an arrangement of light sources to be disposed on the substrate. In some examples, the substrate may include an elastic membrane or may be otherwise conformable to a curved surface profile, for example, for lens applications. Electrodes may have associated electrical contacts (e.g., electrical contacts 420 in FIG. 4) that may be used to connect to circuitry outside of the substrate. In some examples, at least one electrical component (not shown) may be in electrical communication with at least one serpentine electrode and may be located between a pair of serpentine electrodes.

FIG. 5 illustrates a cross-section of an exemplary adjustable fluid lens that may be used in connection with various embodiments. In some examples, FIG. 5 may represent a cross-section through a circular lens, though examples may also include non-circular lenses. An adjustable fluid lens may include an elastic membrane 550 that may provide a substrate for at least one electrode, such as the pair of serpentine electrodes 570. In some examples, the electrodes may be formed on the elastic membrane prior to fabrication of the lens, for example, with the elastic membrane in planar configuration.

The lens 500 may be an adjustable fluid lens including a base layer 502 (which in this example may include a rigid, planar, curved lens, and/or transparent substrate), an elastic membrane 550, a fluid 508 (denoted by dashed horizontal lines), an edge seal 585, and a flexure support 590 providing a rigid support to the flexures shown generally as flexures 504. A pair of similar flexures 504 are shown on an opposite side of the lens, and in some examples, flexures may be arranged around the lens periphery. In this example, flexures 504 may include an elastic element 510, and a rigid element 540 including the rigid arm 560 that provides the membrane attachment. The rigid arm provides a control point for the membrane where the membrane may be attached to the rigid arm at 554. The base layer 502 may have a lower (as illustrated) exterior surface, and an interior surface which may optionally support a substrate coating. In this example, the interior surface of the base layer 502 may be in contact with the fluid 508. The elastic membrane 550 has an upper (as illustrated) outer surface and an interior surface enclosing the fluid 508. The outer surface may be used to support the pair of serpentine electrodes 570. The dashed vertical line indicates the center of the fluid lens and the optic axis of the lens 500.

The fluid 508 may be enclosed within a cavity (e.g., an enclosed fluid volume) at least in part defined by the base layer 502, the elastic membrane 550, and the edge seal 585, which may cooperatively help define the cavity in which the fluid is located. The edge seal 585 may extend around the periphery of the cavity, and retain (in cooperation with the substrate and the membrane) the fluid within the enclosed fluid volume. The elastic membrane 550 may have a curved profile, so that the lens fluid has a greater thickness (e.g., a distance measured along the lens optical axis) in the center of the lens, compared to the periphery of the lens (e.g., proximate the edge seal 585). In some examples, the fluid lens may be a plano-convex lens, with the planar surface being provided by the base layer 502, and the convex surface being provided by the elastic membrane 550. A plano-convex lens may have a thicker layer of lens fluid near the center of the lens. However, other configurations are possible, such as a plano-concave lens configuration in which the membrane curves in towards the substrate near the center of the lens. The substrate may also have a curved surface that provides optical power to the fluid lens.

An example fluid lens may have a plurality of flexures arranged around the periphery (or within a peripheral region) of the base layer 502. The flexures 504 may attach the membrane to the substrate, optionally through a flexure support 590. An actuator may be used to adjust an optical power of the lens. In some examples, one or more electroactive components supported by the elastic membrane may be used to adjust the lens profile and hence optical power.

The lens 500 may include one or more actuators (not shown in FIG. 5), which may be located around the periphery of the lens, and may be part of or mechanically coupled to the flexures 504. The actuators may exert a controllable force on the elastic membrane 550 through one or more control points, such as control point 554, which may be used to adjust the curvature of the membrane surface and hence one or more optical properties of the lens (e.g., focal length, astigmatism correction, cylindricity, and the like). For example, an actuator may be mechanically coupled to the rigid element 540. In some examples, the control point may be attached to a peripheral portion of the membrane, and may be used to control the curvature of the membrane.

FIGS. 6A-6D show example serpentine electrodes in accordance with various embodiments. In some examples, a serpentine electrode may have a generally sinusoidal form. However, other shapes may be used as discussed herein.

FIG. 6A shows part of an example apparatus 600 including a pair of serpentine electrodes 610 (including first electrode 602 and second electrode 604) formed on a substrate 612. The figure illustrates that, in some examples, the spatial pitch of the serpentine oscillations may vary. For example, the first sinusoid portion 614 has a larger spatial pitch than the second sinusoid portion 616. The dashed line denoted “X” denotes a general path of the electrodes, discussed further below. In some examples, the spatial pitch of a serpentine electrode may be determined as the distance between neighboring locations where the serpentine electrode crosses its general path. For example, the general path may include a smooth curve about which the serpentine electrode has a spatially oscillating path. In some examples, the substrate may be or include an optical element (e.g., a lens, window, polarizer, or reflector), an electronic display, or other device.

FIG. 6B shows an example pair of serpentine electrodes 620 formed on a substrate 622. The figure illustrates that, in some examples, the spatial amplitude of the serpentine oscillations may vary. For example, the sinusoid portion 626 has a larger spatial amplitude than the sinusoid portion 624.

FIG. 6C shows an example pair of serpentine electrodes 630 formed on a substrate 632. The figure illustrates that, in some examples, the serpentine electrode may include linear portions, such as linear portion 636, interconnected by curved portions 634. In some examples, a serpentine electrode may have a shape similar to that of a rounded triangular wave.

In some examples, a serpentine electrode may have a shape that includes lateral deviations from a general path. The serpentine electrode may extend along the direction of the general path and include deviations along a direction normal to the general path. For example, a serpentine electrode with a sinusoidal form may have a maximum deviation denoted A from the general path. In some examples, the maximum deviation A may represent the amplitude of a sinusoidal form Asin(d), where A represents amplitude and d is a parameter based on (e.g., proportional to) a distance along the general path. For example, in FIG. 2 discussed above, the general path of the serpentine electrodes may have a radial direction.

In some examples, a serpentine electrode may include a deviation along a direction parallel to the general path and may, for example, include an S-shaped portion.

FIG. 6D shows a serpentine electrode 640 supported on substrate 642. The serpentine electrode includes an S-shaped portion 644, including a portion in which the electrode reverses direction along the general path.

In some examples, the general path may extend along a radial direction. In some examples, the general path may have a circumferential form around a circular path or portion thereof. In relation to FIGS. 6A-6D, the general path may be a linear path through the center of the serpentine electrode path extending in a horizontal direction as illustrated. An example general path is indicated as a dashed line labeled “X” in FIG. 6A.

In some examples, the general path may be curved or may itself be serpentine. A serpentine general path may extend along a direction that may be termed a second-order general path, and the second order general path may be linear, curved, or itself serpentine.

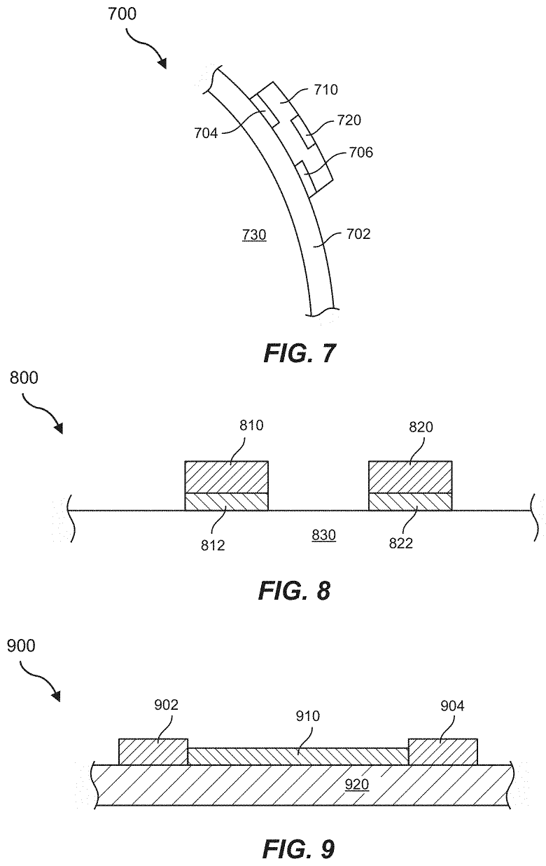

FIG. 7 shows a portion of an example apparatus including an electrical component mounted to a substrate that supports electrodes in accordance with various embodiments. The apparatus 700 includes a membrane 702 enclosing a volume 730 (e.g., that may be a portion of a fluid-filled volume of an adjustable fluid lens), and supports electrodes 704 and 706 on a surface of the membrane 702. An electrical component 710 may be supported by the membrane 702 and is in electrical communication with electrodes 704 and 706. Internal electrical connections within the electrical component 710 are not shown, but in some examples may include electrical connections between active element 720 and the electrodes 704 and 706. In some examples, the active element 720 may include a light emissive and/or light sensitive element. In some examples, the electrical component may include an electrooptical component such as a light-emissive device such as a light-emitting diode (LED), laser (e.g., a semiconductor laser such as a VCSEL), or an optical sensor. In some examples, the electrical component may include a light-sensitive device such as a photoresistor, photodetector (e.g., including a photoelectric device), an image sensor, or the like.

FIG. 8 shows electrodes attached to a substrate using an attachment layer in accordance with various embodiments. An apparatus 800 may include electrodes 810 and 820 attached to substrate 830. In some examples, the electrodes 810 and 820 are attached to the substrate 830 using attachment layers 812 and 822 respectively. In some examples, attachment layers 812 and 822 may include an adhesive layer.

In some examples, an attachment layer may be located between an electrode, such as a serpentine electrode, and a substrate, such as an elastic membrane. In some examples, an attachment layer may include an elastomer, and the elastomer may reduce the elastic strain applied to the electrode by any particular deformation of the substrate. In some examples, an attachment layer may include a relatively rigid layer (e.g., a layer more rigid than the substrate) that may take some portion of the strain exerted by deformation of the substrate. In some examples, an attachment layer may have a multilayer structure and may include one or more of at least one adhesive layer, at least one elastomer layer, or at least one rigid layer. In some examples, an attachment layer may have a serpentine form that conforms to or is otherwise in positional register with a serpentine electrode. In some examples, an attachment layer may extend laterally beyond the serpentine electrode. In some examples, an attachment layer may support one or more electrodes, such as one or more serpentine electrodes.

FIG. 9 shows an electroactive element located between a pair of electrodes in accordance with various embodiments. Apparatus 900 includes substrate 920, first electrode 902, and second electrode 904. An electroactive layer 910 (e.g., an electrostrictive polymer layer) may be located between the first electrode 902 and second electrode 904. At least one of the first or second electrodes may be or include a serpentine electrode.

In some examples, an electric field applied between first electrode 902 and second electrode 904 may induce an electroactive effect in the electroactive layer 910. An example electroactive effect may include electroconstriction that may induce an electroconstriction of the electroactive layer, for example, a compression of the electroactive layer along a direction between the electrodes. The electroactive layer 910 may become thicker. The electroconstriction may induce a similar compression of the substrate 920. In some examples, the substrate 920 may be curved, and may be the curved elastic membrane of an adjustable fluid lens. One or more electroactive layers may be used to control the optical power of the adjustable fluid lens, for example, in electrical contact with at least one serpentine electrode.

In some examples, an apparatus may include a membrane (e.g., an elastic membrane) that may be used as a substrate for first and second electrodes. An electroactive layer may be located between at least a portion of each electrode. The electroactive layer may be attached to the substrate, for example, using an adhesive layer or other approach. In some examples, the membrane may be electroactive and a separate electroactive layer may be omitted. Application of a voltage between the electrodes may adjust the strain within the membrane and may allow, for example, control of the optical power of an adjustable fluid lens.

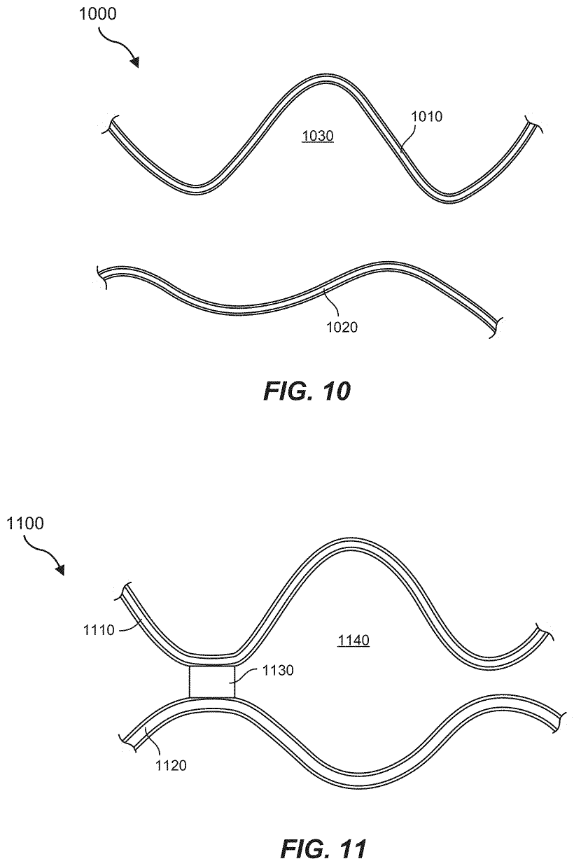

FIG. 10 shows example neighboring serpentine electrodes (which may be pairs of electrodes or individual electrodes) without a spatial phase relationship in accordance with various embodiments. Apparatus 1000 includes first serpentine electrode 1010 and second serpentine electrode 1020, both supported on substrate 1030. The figure illustrates that one or more of the pitch, amplitude or phase of the first and second serpentine electrodes may have no appreciable correlation with each other. The first and second serpentine electrodes may be neighboring electrodes on a substrate. In some examples, the electrodes may have similar general directions (e.g., parallel horizontal general directions as illustrated). In some examples, the average trajectory of a serpentine pair of electrodes may not itself be serpentine.

FIG. 11 shows an example of neighboring serpentine electrodes (which may be pairs of electrodes or individual electrodes) with an electrical component located between neighboring portions in accordance with various embodiments. Apparatus 1100 includes a first serpentine electrode 1110, a second serpentine electrode 1120, and an electrical component 1130 located in electrical communication with both electrodes, the electrodes being supported by substrate 1140. In some examples, an electrical component may be located at a location where the electrodes are close together. For example, a lateral deviation of one or both electrodes may bring the electrodes relatively close together, for example, with a separation of approximately equal to or less than 5 mm, such as approximately equal to or less than 2 mm, for example, approximately equal to or less than 1 mm.

FIG. 12 shows a schematic of an example apparatus including a controller in accordance with various embodiments. Apparatus 1200 includes controller 1210 in communication with a light source 1230 (or, e.g., other electrical component) through at least one serpentine electrode, in this example, a pair of serpentine electrodes 1220. The controller may also be in communication with a light sensor 1250 through at least one serpentine electrode, in this example, a pair of serpentine electrodes 1240. The serpentine electrodes 1220 and 1240 may be the same electrodes or different.

FIG. 13 shows a further example apparatus including a controller in accordance with various embodiments. Apparatus 1300 includes controller 1310 in communication with an electroactive element 1330 through at least one serpentine electrode, in this example, a pair of serpentine electrodes 1320. The controller may apply a control voltage to electroactive element 1330 to adjust a device configuration, such as an optical power of an adjustable lens.

In some examples, a controller may apply a control voltage to adjust the electrostriction of the electroactive element, for example, to control the optical power of an adjustable fluid lens. An electrostrictive element of any suitable shape may be located between a first electrode and a second electrode. One or both electrodes may be, at least in part, serpentine electrodes.

FIG. 14 shows a further optical configuration in accordance with various embodiments. Optical configuration 1400 includes a display 1405, beamsplitter 1420, lens 1430 and a polarized reflector 1440. Light beams emitted by the display are shown as dashed lines. A light ray 1445 is emitted by a display portion 1410 of display 1405, passes through the beamsplitter 1420 and lens 1430, and is reflected back as ray 1450 from the polarized reflector 1440. Refraction at the lens surfaces is not shown for illustrative convenience. The ray 1450 is then reflected by the beamsplitter 1420 to give ray 1455 which passes through the polarized reflector 1440 and is directed towards the eye of a user as ray 1460. Stray light beams such as light beam 1452 may reduce the beam intensity that reaches the eye of a user. The eye of a user is not shown, but a viewing location such as an eyebox may be located to the right of the optical configuration as illustrated. In some examples, the beamsplitter 1420 may be formed as a partially reflective film (e.g., a thin metal film) on the convex lens surface 1425 of the lens 1430. In some examples, the optical configuration may further include an optical retarder which may, for example, be included as a layer formed on surface 1435 of the polarized reflector 1440. In some examples, the beamsplitter 1420 may be replaced by a polarized reflector, for example, a second polarized reflector which may reduce losses associated with the beamsplitter and may be non-electrically conductive. In some examples, a polarized reflector or beamsplitter may have no appreciable electrical conductivity so as not to electrically modify the properties of a serpentine electrode. In some examples, a beamsplitter may be used in place of the polarized reflector 1440.

Improvements in the optical configuration 1400 may be desirable, such as electrical adjustment of the optical power of the lens 1430 and/or the provision of an eye tracking system using light sources and/or sensors associated with the lens. In some examples, the lens 1430 may be an adjustable fluid lens, for example, as described above in relation to FIG. 5. In some examples, a light source associated with eye tracking may be located within the field of view of the lens and one or more serpentine electrodes may be advantageously used to provide an electrical connection to the light source. The serpentine shape of an example electrode may provide one or more advantages in such a configuration, such as reduced user perception of the electrode, improved mechanical resistance to breakage under deformation of an underlying lens surface (e.g., in an adjustable lens), and improved conformability to a curved surface. Example light sources, such as one or more semiconductor lasers and/or light-emitting diodes, may be located on a curved surface of the lens. In some examples, a serpentine electrode may be supported on a convex lens surface 1425 of lens 1430, and this may include support by an additional layer formed on the lens surface such as beamsplitter 1420 or any other layer conforming to the lens surface. In some examples, a lens surface may be convex, concave, or planar, and any such surface may support a serpentine electrode. In some examples, a serpentine electrode supported by a lens may be supported by a lens coating such as an anti-scratch coating, anti-reflection coating, or the like. In some examples, a serpentine electrode may be supported on a lens and an additional coating may be formed to cover the lens, such as a beamsplitter (e.g., a non-electrically conducting beamsplitter such as a multilayer beamsplitter), a reflective polarizer, or other layer.

In some examples, the curved surface may be adjustable. Serpentine electrodes may facilitate provision of electrical connections having improved reliability on an adjustable curved surface. In some examples, adjustment of the lens curvature may include application of an electric field to an electroactive element located on or within the lens. In some examples, at least one actuator may be used to adjust the optical power of the lens, and a serpentine electrode may be used to provide an electrical connection to a light source located or otherwise supported by the lens. Serpentine electrodes may facilitate electrical connections to electrical components and/or electroactive elements associated with the lens.

In some examples, the lens may include a Fresnel lens and the curvature of individual facets of the Fresnel lens may be electrically adjustable using approaches such as those discussed herein.

Methods of Fabrication

FIG. 15 shows an example method of fabricating an apparatus in accordance with various embodiments. The method 1500 includes forming a lens having a lens surface (1510), depositing a serpentine electrode on the lens surface (1520), and locating an electrical component on the lens surface in electrical communication with the serpentine electrode (1530). A method may further include forming a second electrode, that may be a second serpentine electrode, on the surface in electrical communication with the electrical component. A method may further include, by a controller, providing an electrical signal to the electrical component (e.g., to induce light emission) and/or receiving a signal (e.g., a sensor signal) from the electrical component (e.g., a light sensor).

In some examples, the lens surface may be provided by an elastic membrane. In some examples, the electrical component may include an electroactive element that may be attached to or otherwise supported by the elastic membrane. A further example method of fabricating an apparatus in accordance with various embodiments may include forming an adjustable lens including an elastic membrane, depositing a serpentine electrode on the elastic membrane, and locating an electrical component on the elastic membrane in electrical communication with the serpentine electrode. A method may further include forming a second electrode, that may be a second serpentine electrode, on the surface in electrical communication with the electrical component. A method may further include, by a controller, providing an electrical signal to the electrical component. In some examples, the electrical component may be an electroactive element and the electrical signal may induce electrostriction of the electroactive element. In some examples, the electrical signal may be used, at least in part, to control the optical power of the adjustable lens.

In some examples, a method for forming a compound curved optical element may include forming a serpentine electrode on a substrate, such as a polymer substrate, while the substrate is in a planar configuration. In some examples, an electrical component may be located on the substrate or otherwise supported by the substrate and may be in electrical communication with at least one serpentine electrode. In some examples, the substrate may be modified to provide a curved surface profile, for example, including a compound curve. For example, a serpentine electrode may be formed on an elastic membrane in a planar configuration, and the elastic membrane may then adopt a curved surface profile in an adjustable lens application. In some examples, modification of the substrate may include at least one of molding, heating, application of an electric field (e.g., to an electroactive element), or application of a force to induce deformation of a substrate, such as bending, stretching, formation of a curved surface profile (e.g., concave, convex, cylindrical, conic, freeform), or the like. A serpentine electrode may include at least a portion having a sinusoidal form.

An electrical component may include a light source such as a light-emitting diode (LED) or a laser. In some examples, the light source may include a visible light emissive light source. In some examples, the light source may include an IR emissive (e.g., near-IR emissive) light source.

In some examples, a serpentine electrode may be formed by lithography of a conducting layer supported by a substrate. A conducting material may be deposited on a substrate as a layer and then processed to form an appropriately configured electrode pattern. Processing approaches may include one or more of laser ablation, lithography, etching, die-cutting, mechanical scoring, or any suitable approach. In some examples, electrodes may be formed on a transfer substrate that may include an elastomer layer, then transferred to the apparatus substrate using any suitable approach.

In some examples, electrodes may be deposited using any suitable patterned deposition approach.

In some examples, a method of fabricating an apparatus may include providing a substrate and attaching one or more electrodes to the substrate. The substrate may include an optical element such as a lens or a component thereof. The electrodes may be attached to the substrate using an adhesive layer. In some examples, electrodes may be adhered to a substrate by a process including one or more of heating, application of pressure, or exposure to radiation such as light or UV radiation. In some examples, an electrode may be coated with a layer of adhesive before the application of pressure. For example, an electrode surface that is urged in contact with the substrate may be coated with a layer of adhesive. The adhesive may include a pressure sensitive, thermally activated, or photocurable material.

In some examples, a method of making an optical element including an adjustable substrate may include conforming and bonding at least one electrode to the substrate, such as at least one serpentine electrode.

Methods of Operating an Apparatus

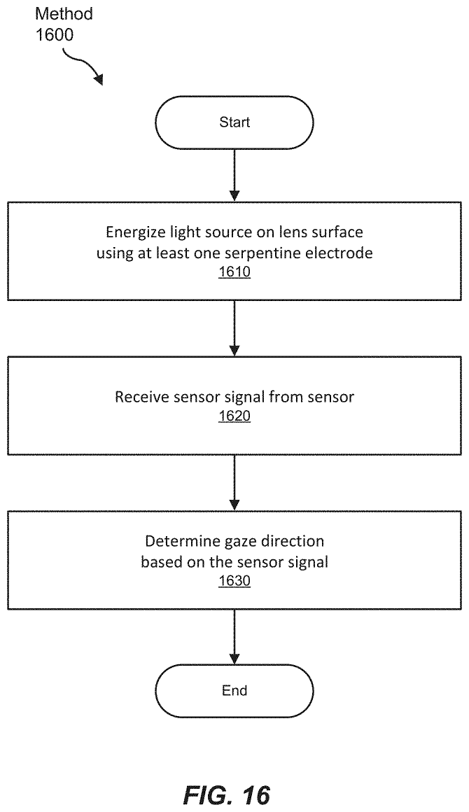

FIG. 16 illustrates an example method of operating an apparatus in accordance with various embodiments. The method (1600) includes applying an electrical signal to energize a light source located on a lens surface through at least one serpentine electrode (1610), receiving a sensor signal from a sensor (1620), and determining a gaze direction based on the sensor signal (1630). The sensor signal may be based on the detection reflected light arising from the illumination of an object, such as the eye of a user, using the light source.

Gaze direction may be determined using an eye tracking system, as discussed in more detail below. An eye tracking system may include at least one light source located on a lens surface and at least one sensor. For example, a method of operating an eye tracking system may include energizing a light source using a first serpentine electrode to obtain a light beam, and detecting a reflection of the light beam from an eye of a user using a sensor signal received using a second electrode, such as a second serpentine electrode.

Example methods of operation may be performed, for example, by an apparatus such as a head-mounted device, such as an AR/VR device. An example method may include emitting a light ray from a light source, and detecting a reflected ray arising from a reflection of the light ray from the eye. In some examples, a user may view an image of a display when the user wears the device. The eye of a user may be located at the eyebox (e.g., a location of display image formation) for viewing the image of the display. An optical assembly may be used to form an image of the display at the eyebox, and the optical assembly may include at least one lens, a reflective polarizer, and a beamsplitter arranged in a folded optic arrangement.

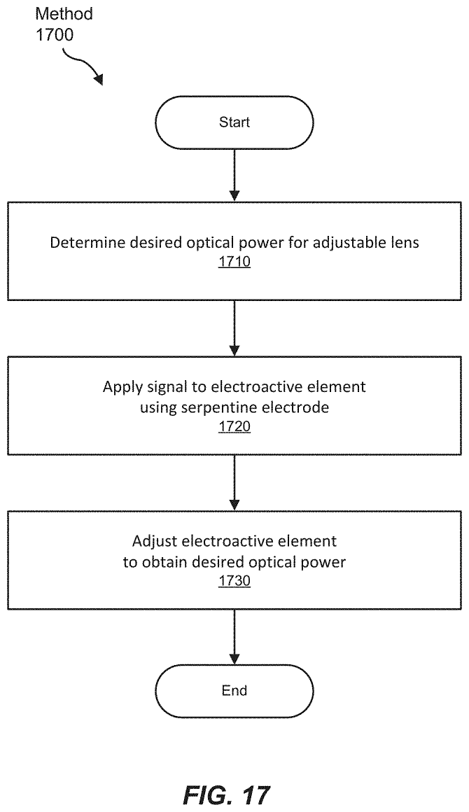

FIG. 17 illustrates a further example method of operating an apparatus in accordance with various embodiments. The method (1700) includes determining a desired optical power for an adjustable lens (1710), applying a signal to an electroactive element using a serpentine electrode (1720), and adjusting (e.g., an electroconstriction) of the electroactive element to obtain the desired optical power (1730).

In some examples, a method of adjusting the optical power of a lens may be performed by a head-mounted apparatus including a display and an optical configuration including a lens. An example method may include applying an electrical signal to an electroactive element located within the aperture of the lens using at least one serpentine electrode. In some examples, within the aperture of the lens may correspond to within a portion of the lens used to form an image of a display viewable by a user of the apparatus. In some examples, the lens may be an adjustable lens including an elastic membrane. In some examples, the electroactive element may include an electro-strictive polymer layer mechanically associated with (e.g., attached to) the elastic membrane of the adjustable lens.

In some examples, a method may further include emitting light having circular or linear polarization from a display, transmitting the light through a first lens assembly, reflecting the light from a second lens assembly, and reflecting the light from the first lens assembly through the second lens assembly and towards an eye of a user. The apparatus may be configured so that the light is transmitted through the first lens assembly having a first polarization and subsequently reflected by the first lens assembly having a second polarization. This may be achieved using an optical retarder located between the first and second lens assemblies and/or using changes in polarization on reflection. A display may inherently emit polarized light or, in some examples, a suitable polarizer may be associated with (e.g., attached to) a surface through which light from the display is transmitted.

Example methods include computer-implemented methods for operating an apparatus, such as an apparatus as described herein such as a head-mounted display or an apparatus for fabricating an apparatus such as described herein. The steps of an example method may be performed by any suitable computer-executable code and/or computing system, including an apparatus such as an augmented reality and/or virtual reality system. In some examples, one or more of the steps of an example method may represent an algorithm whose structure includes and/or may be represented by multiple sub-steps. In some examples, a method for providing a uniform image brightness from a display using a folded optic configuration may include using a display panel that is configured to allow a spatial variation of the display brightness.

In some examples, an apparatus, such as a device or system, may include at least one physical processor and physical memory including computer-executable instructions that, when executed by the physical processor, cause the physical processor to generate an image on the display. The image may include a virtual reality image element and/or an augmented reality image element. The apparatus may include an optical configuration such as described herein.

In some examples, a non-transitory computer-readable medium may include one or more computer-executable instructions that, when executed by at least one processor of an apparatus (e.g., a head mounted device), cause the apparatus to provide an augmented reality image or a virtual reality image to the user (e.g., the wearer of the head mounted device). The apparatus may include an optical configuration such as described herein.

In some examples, an apparatus (e.g., a head mounted device such as an AR and/or VR device) may include an optical configuration including a pancake lens (e.g., a combination of a lens and a beamsplitter, which may also be termed a beamsplitter lens) and a reflective polarizer. An example reflective polarizer may be configured to reflect a first polarization of light and transmit a second polarization of light. For example, a reflective polarizer may be configured to reflect one handedness of circularly polarized light (e.g., right or left) and transmit the other handedness of circularly polarized light (e.g., left or right, respectively). For example, a reflective polarizer may be configured to reflect one direction of linear polarized light (e.g., vertical) and transmit an orthogonal direction of linearly polarized light (e.g., horizontal). In some examples, the reflective polarizer may be adhered to the facets of a Fresnel lens.

The optical configuration may be termed a folded optic configuration, and in this context, a folded optic configuration may provide a light path that includes one or more reflections and/or other beam redirections. An apparatus having a folded optic configuration may be compact, have a wide field-of-view (FOV), and allow formation of high-resolution images. Higher lens system efficiency may be useful for applications such as head-mounted displays (HMDs), including virtual reality and/or augmented reality applications.

An example device may include a display, a pancake lens (e.g., including a beamsplitter or polarized reflector that may be formed as a coating on a lens surface), and a reflective polarizer (e.g., configured to reflect a first polarization of light and transmit a second polarization of light, where the first polarization and second polarization are different). For example, a reflective polarizer may be configured to reflect one handedness of circular polarized light and transmit the other handedness of circularly polarized light.

In some examples, an optical retarder may be located between first and second lens assemblies, and the light from the display may pass through the optical retarder on a plurality of occasions (e.g., three times) before being transmitted through the second lens assembly towards the eye of the user. In some examples, light may be emitted from the display with a polarization, such as a linear polarization or a circular polarization. The polarization may be modified by the optical retarder each time the light passes through the optical retarder. Reflections may also modify the polarization of light. For example, light (e.g., polarized light) from the display may be transmitted through the first Fresnel lens assembly, pass through the optical retarder, be reflected by the second Fresnel lens assembly, pass through the optical retarder, be reflected by the first Fresnel lens assembly, pass through the optical retarder, and then be transmitted by the second Fresnel lens assembly towards the eye of a user, where the light may be incident on the reflective polarizer with a first linear polarization, which may be reflected by the reflective polarizer of the second Fresnel lens assembly. Light may reflect from the reflective polarizer of the first Fresnel lens assembly and may then be transmitted by the reflective polarizer. In some examples, at least one of the Fresnel lens assemblies may include an optical retarder and the separate optical retarder may be omitted from the optical configuration.

Folded optic configurations may be compact, have a wide field-of-view (FOV), and provide higher resolution for a given distance between the display and a viewer. However, a folded optic configuration including a pancake lens may have a lower efficiency than a non-folded optical configuration including refractive lenses but no reflective elements. System efficiency of an optical configuration is important, for example, for applications in Head-Mounted Displays (HMDs). Reduced efficiency can reduce the usability of an AR/VR device and may create discomfort due to higher temperatures as a result of an increased power consumption required by the display to provide a desired image brightness. In some examples, system efficiency is increased using a pancake lens including a beamsplitter that has higher reflectance toward the edges of the beamsplitter than within a central region of the beamsplitter. Lens efficiency may be increased using a polarization-converting beamsplitter lens including a beamsplitter that has higher reflectivity toward the edges of the lens than within a central region of the lens. In some examples, a pancake lens may include a refractive lens and a beamsplitter that may be formed as a reflective coating on a surface of the lens. The reflective coating may have a spatially varying reflectance. In some examples, a pancake lens may include a polarization-converting beamsplitter lens.

In some examples, a structured optical element such as a Fresnel lens may include a substrate having a surface including facets and steps, where the steps are located between neighboring (e.g., proximate or substantially adjacent) facets. A reflective polarizer may be located adjacent to and conforming to at least a portion of a faceted surface. In some examples, a faceted surface may correspond to a surface portion of a refractive lens, such as a convex or concave surface, and may be curved. In some examples, a faceted surface may be planar and approximate a surface portion of a refractive lens. For example, a planar faceted surface may have an orientation to the optic axis of the lens that varies with the average (e.g., mean) radial distance of the facet from the optical center of the lens. In this context, a structured optical element may include surface facets separated by steps, and at least one facet of a Fresnel lens may support a reflective polarizer. The filler material may then coat a surface of a Fresnel lens assembly (e.g., including facets, steps and the reflective polarizer). The filler layer may have a first surface having a profile that is complementary to the Fresnel lens assembly, and a second surface (e.g., an exterior surface) that may be a planar surface. In some examples, the second surface of the filler material may have a curved surface, such as a convex, concave, cylindrical, freeform, or other curved surface, or, in some examples, may include a second Fresnel lens structure.

A serpentine electrode may be formed on one or both surfaces of a lens, such as a Fresnel lens or any other lens.

A lens assembly may include a lens and a reflective polarizer and/or a beamsplitter (e.g., a partially reflective film formed on the lens surface). A lens surface may planar surface, a cylindrical surface, a freeform surface, a surface defined at least in part by a Zernike function, or a spherical surface. A serpentine electrode may be formed on any form of lens surface, including a lens surface of an adjustable lens.

An adjustable lens may have an adjustable surface that may include an elastic membrane, an elastomer, or other adjustable form. A serpentine electrode may be used to provide electrical contact to electrical components supported by the adjustable surface, and/or to control the curvature using an electroactive element in mechanical communication with the lens surface (e.g., a membrane). In some examples, a serpentine electrode may be used to provide signals to electroactive elements embedded in a lens, or to provide a signal to any electroactive lens component.

In some examples, a serpentine electrode may be supported on a surface of a fluid, for example, by the surface tension. In some examples, an electric signal provided by a serpentine electrode may be used to control a radius of curvature of a liquid droplet or liquid layer.

In some examples, a lens may include a Fresnel lens having a plurality of facets and steps between the facets that would otherwise form a continuous lens surface. A Fresnel lens may effectively divide the curved surface of a refractive lens into a plurality of facets. The facets may include curved portions (or planar approximations thereof) that approximate respective portions of the convex surface. There may be steps between the facets that allow the thickness of a Fresnel lens to be significantly less than that of a traditional convex lens. In some examples, a serpentine electrode may be disposed on a structured surface of a Fresnel lens, a filler layer applied over the structured surface of a Fresnel lens, or an unstructured surface of a Fresnel lens (e.g., to a planar, concave, or convex surface of a Fresnel lens also including a structured surface including steps between facets).

In some examples, the optical configuration (e.g., of an AR/VR system) may include a lens (e.g., a Fresnel lens or other refractive lens). An example optical system may also include a beamsplitter and/or a polarized reflector. In some examples, a lens may be concave, convex, may have a complex optical profile such as a freeform surface. In some examples, a surface of an adjustable lens may be adjustable between one or more profiles, such as between two or more different optical powers. Optical configurations may be used in augmented reality and/or virtual reality (AR/VR) systems. In some examples, an optical configuration may include a lens and at least one other optical component, such as one or more of a reflective polarizer, an optical filter, an absorbing polarizer, a diffractive element, an additional refractive element, a reflector, an antireflection film, a mechanically protective film (e.g., a scratch-resistant film), a beamsplitter, other optical component, or combination thereof. An optical configuration including a lens may further include at least one of a beamsplitter, a polarized reflector, or an optical retarder.

In some examples, an apparatus may include a wearable device (e.g., a head-mounted device). An example apparatus may include a display and an optical configuration configured to form an image of a display viewable by a user when the user wears the wearable device. Example applications may include adjustable lenses or eye-tracking systems used, for example, in imaging, display, or projection apparatus.

In some examples, an apparatus may include a reflective polarizer. An example reflective polarizer may be configured to reflect one polarization of light and transmit another polarization of light. For example, an example reflective polarizer may reflect one handedness of circularly polarized light and may transmit the other handedness of circularly polarized light. In some examples, a reflective polarizer may reflect one linear polarization direction and transmit an orthogonal linear polarization direction. In some examples, serpentine electrodes may be located on optical components such as polarizers (e.g., reflective or transmissive polarizers). In some examples, at least one serpentine electrode and at least one electrical component may be supported on a surface of a polarizer.

Example reflective polarizers include, without limitation, cholesteric reflective polarizers (CLCs) and/or multilayer birefringent reflective polarizers. Other examples are discussed below. A reflective polarizer, for example, may be configured to reflect a first polarization of light and transmit a second polarization of light. In this context, reflection may correspond to reflection of at least 60% of the incident light intensity and transmission may correspond to transmission of at least 60% if the incident light intensity. In some examples, a reflective polarizer may reflect one handedness of circular polarized light and transmit the other handedness of circularly polarized light. In some examples, an apparatus may include a beamsplitter lens or, in some examples, a second Fresnel lens assembly. A beamsplitter lens may include a beamsplitter formed as a coating on a lens or otherwise supported by a lens surface.

In some examples, a reflective polarizer may include a cholesteric liquid crystal, such as a polymer cholesteric liquid crystal. In some examples, a reflective polarizer may include a birefringent multilayer reflective polarizer. In some examples, an apparatus may further include an optical retarder, such as a quarter wave retarder, located between the beamsplitter and the reflective polarizer.

Example reflective polarizers (or other polarizers) may include polarizing films. An example polarizing film may include one or more layers, such as an optical polarizer including a combination of a reflective polarizer and a dichroic polarizer, for example, bonded together.

In some examples, an example reflective polarizer may include a cholesteric liquid crystal, a birefringent multilayer optical film, a wire grid, or other arrangement of electrically conductive elements. The reflective polarizer may include a birefringent multilayer film, and the skin layer or layers may have a pass polarization refractive index that is within 0.2 of the average refractive index of the multilayer film, and in some examples, a refractive index that differs from the average refractive index of the multilayer film by at least approximately 0.02, such as at least approximately 0.05, for example, at least approximately 0.1.

In some examples, the reflective polarizer may be patterned to be in registration with the facets of the Fresnel lens. The patterned reflective polarizer may be formed on an elastomer element, aligned with the facets, and then the elastomer element may be moved (e.g., by an actuator) so that the patterned reflective polarizer is urged in contact with the facets of the Fresnel lens.

In some examples, a reflective polarizer may be fabricated by applying an alignment layer (e.g., a polymer layer or grating) to a surface (e.g., a surface of a lens or other optical component) and applying a cholesteric liquid crystal (CLC) layer that may be at least partially aligned with the alignment layer. An example alignment layer may include a photoalignment material (PAM) that may be deposited on a substrate, and a desired molecular orientation may be obtained by exposing the PAM to polarized light (such as ultraviolet (UV) and/or visible light). A CLC layer may be further processed to lock the molecular alignment of a CLC within a solid material, for example, to provide a chiral material such as a chiral solid. For example, a CLC may be polymerized, cross-linked, and or a polymer network may be formed through the CLC to stabilize the alignment. In some examples, a CLC may be formed using an effective concentration of chiral dopant within a nematic liquid crystal, and the chiral nematic (cholesteric) mixture may further include at least one polymerizable material.

In some examples, a reflective polarizer may include a chiral material such as a material having molecular ordering similar to that of a cholesteric liquid crystal, such as a solid material derived from cooling, polymerizing, cross-linking, or otherwise stabilizing the molecular order of a cholesteric liquid crystal. For example, a chiral solid may be a solid having a helical optical structure similar to that of a cholesteric liquid crystal. For example, a direction of maximum refractive index may describe a helix around a normal to the local direction of molecular orientation.

In some examples, a reflective polarizer may include a birefringent multilayer optical film that may be conformed to a lens surface, for example, through a combination of heat and pressure. In some examples, a serpentine electrode may be supported by an optical film disposed on a lens surface.

In some examples, a polarizing beam splitter may include a transparent lens with a first and a second surface, where the first surface is a Fresnel lens, and the second surface is adjacent to a reflective polarizing layer. At least one of the first and second surfaces may have a cylindrical, spherical, or aspherical curvature.

A serpentine electrode may be supported by one or both surfaces of a lens or other optical element.

In some examples, an optical configuration (e.g., of an AR/VR device) may include a beamsplitter (e.g., instead of or additional to a polarizing reflector). A beamsplitter may be configured to reflect a first portion of incident light and transmit a second portion of incident light. In some examples, a beamsplitter lens may be used with a Fresnel lens assembly. A beamsplitter may be formed on the facets of a Fresnel lens using approaches adapted from those described herein. For example, a beamsplitter may be formed on an elastic element. A beamsplitter may be formed on a substrate such as a lens. In some examples, at least one serpentine electrode and at least one electrical component may be supported on a surface of a beamsplitter.

Reflective layers may be formed by one or a combination of processes including thin film physical vapor deposition, chemical vapor deposition, or other suitable processes for depositing reflective layers, such as highly and/or partially reflective thin film coatings. An example reflective layer may include one or more metals such as aluminum or silver, and may be metallic. An example reflective layer may include one or more dielectric materials such as silica, aluminum oxide, hafnium oxide, titanium dioxide, magnesium oxide, magnesium fluoride, indium tin oxide, indium gallium zinc oxide, and the like, and mixtures thereof. An example reflective layer may include one or more dielectric layers, and may include a Bragg grating structure or similar multilayer structure.

An example beamsplitter may include one or more regions having different transmissivity and/or reflectance, and may include one or more reflective layers. An example beamsplitter may include first and second regions, having a different reflectance, for example, for visible light or at least one visible wavelength of light. A beamsplitter may include a coating formed on a surface of the lens, such as a metal coating and/or a dielectric coating such as a dielectric multilayer. In some examples, the reflectance of the beamsplitter may vary as a function of spatial position within the beamsplitter. For example, a beamsplitter may include a first region having a first reflectance and a second region having a second reflectance. In some examples, a beamsplitter may have a higher reflectance toward the edges of the beamsplitter than within a central region of the beamsplitter.

An example beamsplitter may include a coating that is partially transparent and partially reflective. An example beamsplitter may include a thin coating including a metal such as gold, aluminum or silver. A thin coating may have a coating thickness in the range of approximately 10 nm to approximately 500 nm. An example beamsplitter may include one or more layers, such as dielectric thin film layers. In some examples, a beamsplitter may include at least one dielectric material, for example, as a dielectric layer or component thereof, such as silica, aluminum oxide, hafnium oxide, titanium dioxide, magnesium oxide, magnesium fluoride, and the like. An example beamsplitter may include a coating including at least one thin metal coating and/or at least one dielectric coating. An example beamsplitter may include at least one of an electrically conductive material (e.g., a metal, an electrically conductive metal oxide such as, indium tin oxide or indium gallium zinc oxide, or other conductive material) and a dielectric material, and may include a combination of an electrically conductive material and a dielectric material (e.g., as a coating including at least one layer).

In some examples, a beamsplitter may be formed on a convex, planar, or concave surface of a lens. In some examples, the lens may include a Fresnel lens. In some examples, a polarized reflector may be configured to function as a beamsplitter and may, for example, be configured to reflect a first percentage of a first polarization of light and a second percentage of a second polarization of light, where the first and second percentages may be different, while transmitting some, most, or effectively all of the non-reflected light.

In some examples, an example reflector (e.g., a beamsplitter, polarized reflector, or other reflector) may include at least a first and a second region, where the first region may include a central region of the reflector, and the second region may include an outer region of the reflector. In some examples, a reflector (e.g., a beamsplitter or a polarized reflector for a particular polarization) may have a reflectance of about 100%, about 95%, about 90%, about 85%, about 80%, about 75%, about 70%, or within a range between any two examples values of these example reflectance values. For example, the second region may have a reflectance between approximately 75% and approximately 100%, such as a reflectance between approximately 85% and approximately 100%. In some examples, the second region may have a higher reflectance than the first region, such as at least 10% higher reflectance. In some examples, the relationship between reflectance and distance may be a monotonic smooth curve. In some examples, the relationship between reflectance and distance may be discontinuous or include transition regions with relatively high rates of change of reflectance. In some examples, there may be a gradual transition in reflectance of the beamsplitter from the first region to the second region within a transition region. The transition region may have a width (which may be termed a transition distance) that may be less than about 5 mm, such as less than 2 mm, such as less than 1 mm. In some examples, the transition region width may be less than 0.1 mm, such as less than 0.01 mm.

In some examples, a reflector (e.g., a beamsplitter or polarized reflector) may include a layer that is partially transparent and partially reflective. In some examples, a reflector may include a metal film formed on a substrate, such as a substrate including one or more optical materials. For example, the layer may include a metal layer (e.g., having a thickness between about 5 nm and about 500 nm, such as a thickness between 10 nm and 200 nm), such as a layer including one or more metals such as aluminum, silver, gold, or other metal such as an alloy. The layer may include a multilayer, and may include a corrosion protection layer supported by the exposed surface of the layer (e.g., on a metal layer). In some examples, the layer may include one or more dielectric layers, such as dielectric thin film layers. Dielectric layers may include one or more dielectric layers such as oxide layers (e.g., metal oxide layers or other oxide layers), nitride layers, boride layers, phosphide layers, halide layers (e.g., metal halide layers such as metal fluoride layers), or other suitable layers. In some examples, the device may include one or more metal layers and/or one or more dielectric layers. A substrate may include glass or an optical polymer.

In some examples, an apparatus may include a display, at least one Fresnel lens assembly including a polarized reflector, and optionally a beamsplitter lens including a beamsplitter. The reflectance of the beamsplitter and/or the polarized reflector may vary as a function of spatial position; for example, including a first region of relatively high optical transmission and a second region of relatively low optical transmission (e.g., of relatively higher reflectance). In this context, a segmented reflector may have at least two regions having different optical properties, such as regions of different values of reflectance, for example, for one or more visible wavelengths.

In some examples, the image brightness provided by the display (e.g., including a display panel) using an optical configuration may include spatially adjusting the spatial profile of the illumination brightness of a light source (e.g., a backlight) and/or an emissive display. Display brightness may be adjusted as a function of one or more display parameters, such as spatial position on the display (e.g., spatial variations in image brightness), power consumption, aging effects, eye response functions, and/or other parameter(s).

In some examples, a device may include a reflector having a gradual or effectively discontinuous transition in the reflectance of the reflector from the first region to the second region. A transition region may be located between the first region and the second region. As measured along a particular direction (e.g., a radial direction, normal to the periphery of the first region, or other direction) the transition region may extend over a transition distance between the first region and the second region. In some examples, the transition distance may have a length that is approximately or less than 5 mm, 1 mm, 0.1 mm, or 0.01 mm.

In some examples, a reflector may provide selective reflection over a particular wavelength range and/or for a particular polarization. For example, a reflector may include a Bragg reflector, and layer composition and/or dimensions may be configured to provide a desired bandwidth of operation.

In some examples, a reflector may be formed on an optical substrate such as a lens, and a combination of a lens and a reflector may be termed a reflector lens. A reflector lens may include an optical element having at least one curved surface. A reflector may include a reflective coating formed on or otherwise supported by a planar or a curved surface of an optical element such as a lens.

During fabrication of a reflector, different reflector regions having different values of optical reflectance may be defined by a masked deposition processes or using photolithography, or a combination thereof. Similar approaches may be used for the fabrication of serpentine electrodes.

In some examples, a lens (such as a Fresnel lens) may include a surface such as a concave surface, a convex surface or a planar surface. In some examples, a device may include one or more converging lenses and/or one or more diverging lenses. An optical configuration may include one or more lenses and may be configured to form an image of at least part of the display at an eyebox. A device may be configured so that an eye of a user is located within the eyebox when the device is worn by the user. In some examples, a lens may include a Fresnel lens having facets formed on an substrate including an optical material. In some examples, an optical configuration may include one or more reflectors, such as mirrors and/or reflectors.

In some examples, at least one serpentine electrode may be formed on a planar or curved (concave or convex) surface of a mirror. In some examples, a mirror may include an elastic membrane and may be adjustable.

In some examples, a serpentine electrode may be defined by a pair of spaced apart gaps in an electrically conducting surface, such as a metal film coated substrate (e.g., a mirror). In some examples, at least one serpentine electrode may be formed in a conducting film (e.g., metal film) based reflector and/or beamsplitter. Spaced-apart serpentine gaps may be formed by any suitable method or combination of methods, such as lithography (e.g., using a photolithographic resist), etching, ablation (e.g., laser ablation), scribing, or other suitable method. The serpentine electrode may be defined between the spaced-apart serpentine gaps (or any other non-conducting regions). In some examples, a serpentine gap may have a thickness of approximately equal to or less than 250 microns.

In some examples, a serpentine electrode may include one or more serpentine wires (e.g., a plurality of wires conforming to a serpentine path), or serpentine arrangement of anisotropic electrically conductive elements such as carbon nanotubes.

In some examples, a component of an optical configuration may include one or more optical materials. For example, an optical material may include glass or an optical plastic. An optical material may be generally transmissive over some or all of the visual spectrum. In some examples, an optical component including a generally transmissive material may have an optical transmissivity of greater than 0.9 for over some all of the visible spectrum.

In some examples, a substrate (e.g., for a reflector), an optical material, and/or a layer (e.g., of an optical component) may include one or more of the following: an oxide (e.g., silica, alumina, titania, other metal oxide such as a transition metal oxide, or other non-metal oxide); a semiconductor (e.g., an intrinsic or doped semiconductor such as silicon (e.g., amorphous or crystalline silicon), carbon, germanium, a pnictide semiconductor, a chalcogenide semiconductor, or the like); a nitride (e.g., silicon nitride, boron nitride, or other nitride including nitride semiconductors); a carbide (e.g., silicon carbide), an oxynitride (e.g., silicon oxynitride); a polymer; a glass (e.g., a silicate glass such as a borosilicate glass, a fluoride glass, or other glass); or other material.

In some examples, optical materials may be selected to provide low birefringence (e.g., less than one quarter wavelength optical retardance, such as less than approximately λ/10, for example, less than approximately λ/20), for example, for a component including the optical material. An optical material may include a silicone polymer such as polydimethylsiloxane (PDMS), cyclic olefin polymer (COP), cyclic olefin copolymer (COC), polyacrylate, polyurethane, polycarbonate, or other polymer. For example, a silicone polymer (e.g., PDMS) optical component may be supported on a rigid substrate such as glass or a polymer (e.g., a relatively rigid polymer compared with the silicone polymer). The substrate for a serpentine electrode may include one or more such optical components.

In some examples, an apparatus may include a display (e.g., a display panel) and a folded optic lens optionally having a segmented reflectance such as described herein. Light from the display panel incident on the folded optic lens may be circularly polarized. The display may be an emissive display or may include a backlight. An emissive display may include a light-emitting diode (LED) array, such as an OLED (organic light-emitting diode) array. In some examples, an LED array may include a microLED array, and the LEDs may have a pitch of approximately or less than 100 microns (e.g., approximately or less than 50 microns, approximately or less than 20 microns, approximately or less than 10 microns, approximately or less than 5 microns, approximately or less than 2 microns, approximately or less than 1 microns, or other pitch value). In some examples, at least one serpentine electrode and at least one electrical component may be supported on a surface of a display, such as a light emissive surface. For example, one or more sensors may be used to monitor light emission intensity and a controller may receive light emission intensity data from the sensor along a serpentine electrode. The controller may detect aging effects or other variations of light emission intensity and may modify the video signal sent to the display driver to compensate for any such effects.

In some examples, the display may emit circularly polarized light. In some examples, the display may emit linear polarized light and an optical retarder may convert the linear polarization to an orthogonal linear polarization. In some examples, the combination of an optical retarder and a linear reflective polarizer may be replaced with an alternative configuration, such as a circularly polarized reflective polarizer which may include a cholesteric liquid crystal reflective polarizer.

In some examples, the reflective polarizer may include a cholesteric liquid crystal, such as a polymer cholesteric liquid crystal, such as a cross-linked polymer cholesteric liquid crystal. In some examples, the reflective polarizer may include a birefringent multilayer reflective polarizer combined with a quarter wave retarder placed between the reflective polarizer and a second reflector (e.g., a beamsplitter or other reflective polarizer).

In some examples, the display may include a transmissive display (such as a liquid crystal display) and a light source, such as a backlight. In some examples, the display may include a spatial light modulator and a light source. An example spatial light modulator may include a reflective or transmissive switchable liquid crystal array.

In some examples, an apparatus may include a display configured to provide polarized light, such as circularly polarized light. A display may include an emissive display (e.g., a light-emitting display) or a display (e.g., a liquid crystal display) used in combination with a backlight.

In some examples, display light from the display incident on the beamsplitter lens is circularly polarized. The display may include an emissive display (such as a light-emitting diode display) or a light-absorbing panel (such as a liquid crystal panel) in combination with a backlight. An emissive display may include at least one LED array, such as an organic LED (OLED) array. An LED array may include a microLED array. An LED array may include LEDs having a pitch of less than about 100 microns (e.g., about 50 microns, about 20 microns, about 10 microns, about 5 microns, about 2 microns, or about 1 microns, etc.).

In some examples, a display may include a spatial light modulator and a light source (e.g., a backlight). A spatial light modulator may include a reflective or transmissive switchable liquid crystal array. In some examples, the light source (e.g., a backlight) may have and/or allow a spatial variation of illumination intensity over the display. In some examples, the light source may include a scanned source such as a scanned laser. In some examples, the light source may include an arrangement of light emissive elements, such as an array of light emissive elements. An array of light emissive elements may include an array of miniLED and/or microLED emissive elements.

In some examples, a display may include one or more waveguide displays A waveguide display may include a polychromatic display or an arrangement of monochromatic displays. A waveguide display may be configured to project display light from one or more waveguides into an optical configuration configured to form an image of at least part of the display at the eye box.

In some examples, the display brightness may be spatially varied to increase the imaged display brightness uniformity by at least, for example, about 10%, for example, about 20%, for example, about 30%, for example, about 40%, or by some other value. The display illumination variation may be dynamically controlled, for example, by a controller. In some examples, the dynamic illumination variation may be adjusted by a controller receiving eye tracking signals provided by an eye tracking system.

In some examples, the display may have a spatially adjustable brightness (e.g., a spatial variation in illumination intensity). In some examples, the adjustable brightness may be achieved by spatially varying the brightness of an emissive display or of a backlight. The display brightness and/or any spatial variation may be adjustable, for example, by a control circuit. In some examples, the light source may include a scannable light source, such as a laser. In some examples, the light source may include an array of light sources, such as an LED backlight. For example, the array of light sources may include a miniLED or microLED array. The display illumination may be spatially varied to increase the imaged display brightness uniformity by at least about 10% (e.g., about 20%, about 30%, about 40%, or other value). The spatial variation of illumination from the backlight may be dynamically adjusted, and the dynamic adjustment may be controlled by an eye tracking system.

In some example, an apparatus may include one or more actuators. For example, one or more actuators may be used to position a reflective polarizer relative to a Fresnel lens (e.g., to place reflective polarizer portions and the facets of the Fresnel lens in register) and/or to urge the reflective polarizer against a Fresnel lens (e.g., using an elastomer element).

Example actuators may include a piezoelectric actuator, which may include a piezoelectric material such as a crystal or ceramic material. Example actuators may include an actuator material such as one or more of the following: lead magnesium niobium oxide, lead zinc niobium oxide, lead scandium tantalum oxide, lead lanthanum zirconium titanium oxide, barium titanium zirconium oxide, barium titanium tin oxide, lead magnesium titanium oxide, lead scandium niobium oxide, lead indium niobium oxide, lead indium tantalum oxide, lead iron niobium oxide, lead iron tantalum oxide, lead zinc tantalum oxide, lead iron tungsten oxide, barium strontium titanium oxide, barium zirconium oxide, bismuth magnesium niobium oxide, bismuth magnesium tantalum oxide, bismuth zinc niobium oxide, bismuth zinc tantalum oxide, lead ytterbium niobium oxide, lead ytterbium tantalum oxide, strontium titanium oxide, bismuth titanium oxide, calcium titanium oxide, lead magnesium niobium titanium oxide, lead magnesium niobium titanium zirconium oxide, lead zinc niobium titanium oxide, lead zinc niobium titanium zirconium oxide as well as any of the previous mixed with any of the previous and/or traditional ferroelectrics including lead titanium oxide, lead zirconium titanium oxide, barium titanium oxide, bismuth iron oxide, sodium bismuth titanium oxide, lithium tantalum oxide, sodium potassium niobium oxide, and lithium niobium oxide. Also lead titanate, lead zirconate, lead zirconate titanate, lead magnesium niobate, lead magnesium niobate-lead titanate, lead zinc niobate, lead zinc niobate-lead titanate, lead magnesium tantalate, lead indium niobate, lead indium tantalate, barium titanate, lithium niobate, potassium niobate, sodium potassium niobate, bismuth sodium titanate, or bismuth ferrite. One or more of the above-listed example actuator materials may also be used as an optical material, a layer (e.g., of an optical component) or a substrate material (e.g., as a substrate for a beamsplitter). In some examples, an actuator may be configured to adjust the position and/or conformation of an optical element, such as a lens.

In-field illumination and/or imaging may be useful for various applications, such as eye tracking with near-eye and wide field-of-view (FOV) optics. In-field illumination may be achieved by locating one or more light sources on a surface of a lens. However, forming circuits on a curved surface may be challenging.

In some examples, methods for fabricating an optical element may include forming one or more electrodes (e.g., a circuit pattern) on a substrate having a planar surface, and then deforming substrate so that the substrate surface adopts curved profile, for example, as a lens. In some examples, a curved substrate may be deformed (e.g., using a stretching force) to have a planar substrate, an electrode deposited, and the substrate may then be reverted to having a planar substrate. Electrodes may include serpentine electrodes. An example circuit may then be fabricated that conforms to a curved surface, for example, of a lens. For example, at least one electrode may be formed on an elastic membrane while the membrane is in a planar configuration, along with any suitable electrical components. The elastic membrane may be a component of an adjustable lens and may adopt a curved profile an operable form of the adjustable lens.

In some examples, an apparatus may include an augmented reality and/or virtual reality (AR/VR) headset. In some examples, an apparatus may include a display and an optical configuration arranged to provide an image of the display to a user of the apparatus. An example optical configuration may include a lens and a reflective polarizer and/or a beamsplitter. An example apparatus may include a display, such as a liquid crystal display or an electroluminescent display (e.g., an LED display), and the display may be configured to emit polarized light.

In some examples, an apparatus may include a display and an optical configuration configured to provide an image of the display, for example, in a head-mounted device. The optical configuration may include a lens. The apparatus may also include an eye tracker (sometimes referred to as an eye-tracking system) including one or more light sources supported by the lens, and optionally one or more sensors that may also be supported by the lens (e.g., an eyeglass lens or a lens of an AR/VR system). Electrical connections may be made to at least one of the light sources using electrode connections including at least one serpentine electrode.

In some examples, a lens may include Fresnel lens having a structured surface including a plurality of facets, and there may be a step between pairs of neighboring facets. An example apparatus may also include a reflective polarizer and/or a beamsplitter, and the optical configuration may be arranged as a folded optic. The optical configuration may form an image of the display viewable by a user when the user wears the apparatus. Examples also include other devices, methods, systems, and computer-readable media. In some examples, the facets of a Fresnel lens may be smoothed using a filler layer, and serpentine electrodes located on the filler layer and/or on a planar surface.

In some examples, a serpentine electrode may be located on both surfaces of an optical element and used to control an electrooptical element located between the serpentine electrodes.

An example apparatus may include a display and an optical configuration configured to provide an image of the display. The optical configuration may include a lens having a lens surface that supports at least one serpentine electrode. The at least one serpentine electrode may be in electrical communication with an electrical component such as an electrooptical component (e.g., including at least one of laser, light-emitting diode, photodiode, or image sensor) or an electroactive component that may show one or more dimensional changes under application of an electric field. An example apparatus may also include a controller in electrical communication with the electrical component through the at least one serpentine electrode. In some examples, at least a portion of an example serpentine electrode may have an approximately sinusoidal shape or other spatially oscillatory shape.

### Example Embodiments

Example 1: An apparatus may include a display; an optical configuration configured to provide an image of the display; and a controller, where the optical configuration includes a lens having a lens surface; the lens surface supports an electrical component and at least one serpentine electrode; and the controller is in electrical communication with the electrical component through the serpentine electrode.

Example 2. The apparatus of example 1, where the serpentine electrode has an approximately sinusoidal shape.

Example 3. The apparatus of any of examples 1 and 2, where the serpentine electrode includes at least one of a metal, a transparent conductive oxide, graphene, or an electrically conductive polymer.

Example 4. The apparatus of any of examples 1-3, where the lens surface supports a first serpentine electrode and a second serpentine electrode; the electrical component has a first terminal in electrical communication with the first serpentine electrode; and the electrical component has a second terminal in electrical communication with the second serpentine electrode.

Example 5. The apparatus of any of examples 1-4, where the apparatus is configured so that the image of the display is formed from light from the display that passes through the lens surface.

Example 6. The apparatus of any of examples 1-5, where the electrical component includes a light source.

Example 7. The apparatus of example 6, where the controller is configured to energize the light source using an electrical signal provided through the at least one serpentine electrode.

Example 8. The apparatus of any of examples 6 and 7, where the light source includes a laser.

Example 9. The apparatus of any of examples 6-8, where the apparatus includes an eye-tracking subsystem, the eye-tracking subsystem includes the light source and a sensor and the sensor is configured to provide a sensor signal to the controller.

Example 10. The apparatus of example 9, where the controller is further configured to determine a gaze direction based on the sensor signal.

Example 11. The apparatus of any of examples 1-10, where the lens is an adjustable lens including an elastic membrane and the serpentine electrode is supported by the elastic membrane.

Example 12. The apparatus of any of examples 1-11, where the electrical component includes an electroactive element and the controller is configured to adjust an optical power of the lens by providing an electrical signal to the electroactive element through the serpentine electrode.

Example 13. The apparatus of example 12, where the controller is configured to apply a control signal to the electroactive element and the control signal induces an electrostriction in the electroactive element.

Example 14. The apparatus of any of examples 12 and 13, where the electroactive element includes an electroactive polymer layer disposed on the elastic membrane.

Example 15. The apparatus of any of examples 1-14, where the image of the display is formed by light emitted by the display that passes through the lens surface.

Example 16. The apparatus of any of examples 1-15, where the apparatus includes a head-mounted device and the image of the display is viewable by a user of the apparatus when the user wears the head-mounted device.

Example 17. The apparatus of any of examples 1-16, where the apparatus includes an augmented reality device or a virtual reality device.

Example 18. A method may include providing at least one serpentine electrode on a surface of a lens and locating a light source on the surface of the lens, the light source being in electrical communication with the at least one serpentine electrode.

Example 19. The method of example 18, where the light source includes a laser and the serpentine electrode has a sinusoidally-shaped electrode portion.

Example 20. A method may include applying an electrical signal to an electroactive element located on an elastic membrane of an adjustable lens using at least one serpentine element supported by the elastic membrane to adjust an optical power of the adjustable lens, where the electroactive element comprises an electro-strictive polymer layer disposed on the elastic membrane.

Embodiments of the present disclosure may include or be implemented in conjunction with various types of artificial reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial reality systems may be designed to work without near-eye displays (NEDs). Other artificial reality systems may include an NED that also provides visibility into the real world (such as, e.g., augmented-reality system 1800 in FIG. 18) or that visually immerses a user in an artificial reality (such as, e.g., virtual-reality system 1900 in FIG. 19). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 18, augmented-reality system 1800 may include an eyewear device 1802 with a frame 1810 configured to hold a left display device 1815(A) and a right display device 1815(B) in front of a user's eyes. Display devices 1815(A) and 1815(B) may act together or independently to present an image or series of images to a user. While augmented-reality system 1800 includes two displays, embodiments of this disclosure may be implemented in augmented-reality systems with a single NED or more than two NEDs.

In some embodiments, augmented-reality system 1800 may include one or more sensors, such as sensor 1840. Sensor 1840 may generate measurement signals in response to motion of augmented-reality system 1800 and may be located on substantially any portion of frame 1810. Sensor 1840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1800 may or may not include sensor 1840 or may include more than one sensor. In embodiments in which sensor 1840 includes an IMU, the IMU may generate calibration data based on measurement signals from sensor 1840. Examples of sensor 1840 may include, without limitation, accelerometers, gyroscopes, magnetometers, other suitable types of sensors that detect motion, sensors used for error correction of the IMU, or some combination thereof.

In some examples, augmented-reality system 1800 may also include a microphone array with a plurality of acoustic transducers 1820(A)-1820(J), referred to collectively as acoustic transducers 1820. Acoustic transducers 1820 may represent transducers that detect air pressure variations induced by sound waves. Each acoustic transducer 1820 may be configured to detect sound and convert the detected sound into an electronic format (e.g., an analog or digital format). The microphone array in FIG. 18 may include, for example, ten acoustic transducers: 1820(A) and 1820(B), which may be designed to be placed inside a corresponding ear of the user, acoustic transducers 1820(C), 1820(D), 1820(E), 1820(F), 1820(G), and 1820(H), which may be positioned at various locations on frame 1810, and/or acoustic transducers 1820(1) and 1820(J), which may be positioned on a corresponding neckband 1805.

In some embodiments, one or more of acoustic transducers 1820(A)-(J) may be used as output transducers (e.g., speakers). For example, acoustic transducers 1820(A) and/or 1820(B) may be earbuds or any other suitable type of headphone or speaker.

The configuration of acoustic transducers 1820 of the microphone array may vary. While augmented-reality system 1800 is shown in FIG. 18 as having ten acoustic transducers 1820, the number of acoustic transducers 1820 may be greater or less than ten. In some embodiments, using higher numbers of acoustic transducers 1820 may increase the amount of audio information collected and/or the sensitivity and accuracy of the audio information. In contrast, using a lower number of acoustic transducers 1820 may decrease the computing power required by an associated controller 1850 to process the collected audio information. In addition, the position of each acoustic transducer 1820 of the microphone array may vary. For example, the position of an acoustic transducer 1820 may include a defined position on the user, a defined coordinate on frame 1810, an orientation associated with each acoustic transducer 1820, or some combination thereof.

Acoustic transducers 1820(A) and 1820(B) may be positioned on different parts of the user's ear, such as behind the pinna, behind the tragus, and/or within the auricle or fossa. Or, there may be additional acoustic transducers 1820 on or surrounding the ear in addition to acoustic transducers 1820 inside the ear canal. Having an acoustic transducer 1820 positioned next to an ear canal of a user may enable the microphone array to collect information on how sounds arrive at the ear canal. By positioning at least two of acoustic transducers 1820 on either side of a user's head (e.g., as binaural microphones), augmented-reality device 1800 may simulate binaural hearing and capture a 3D stereo sound field around about a user's head. In some embodiments, acoustic transducers 1820(A) and 1820(B) may be connected to augmented-reality system 1800 via a wired connection 1830, and in other embodiments acoustic transducers 1820(A) and 1820(B) may be connected to augmented-reality system 1800 via a wireless connection (e.g., a BLUETOOTH connection). In still other embodiments, acoustic transducers 1820(A) and 1820(B) may not be used at all in conjunction with augmented-reality system 1800.

Acoustic transducers 1820 on frame 1810 may be positioned in a variety of different ways, including along the length of the temples, across the bridge, above or below display devices 1815(A) and 1815(B), or some combination thereof. Acoustic transducers 1820 may also be oriented such that the microphone array is able to detect sounds in a wide range of directions surrounding the user wearing the augmented-reality system 1800. In some embodiments, an optimization process may be performed during manufacturing of augmented-reality system 1800 to determine relative positioning of each acoustic transducer 1820 in the microphone array.

In some examples, augmented-reality system 1800 may include or be connected to an external device (e.g., a paired device), such as neckband 1805. Neckband 1805 generally represents any type or form of paired device. Thus, the following discussion of neckband 1805 may also apply to various other paired devices, such as charging cases, smart watches, smart phones, wrist bands, other wearable devices, hand-held controllers, tablet computers, laptop computers, other external compute devices, etc.

As shown, neckband 1805 may be coupled to eyewear device 1802 via one or more connectors. The connectors may be wired or wireless and may include electrical and/or non-electrical (e.g., structural) components. In some cases, eyewear device 1802 and neckband 1805 may operate independently without any wired or wireless connection between them. While FIG. 18 illustrates the components of eyewear device 1802 and neckband 1805 in example locations on eyewear device 1802 and neckband 1805, the components may be located elsewhere and/or distributed differently on eyewear device 1802 and/or neckband 1805. In some embodiments, the components of eyewear device 1802 and neckband 1805 may be located on one or more additional peripheral devices paired with eyewear device 1802, neckband 1805, or some combination thereof.

Pairing external devices, such as neckband 1805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1800 may be provided by a paired device or shared between a paired device and an eyewear device, thus reducing the weight, heat profile, and form factor of the eyewear device overall while still retaining desired functionality. For example, neckband 1805 may allow components that would otherwise be included on an eyewear device to be included in neckband 1805 since users may tolerate a heavier weight load on their shoulders than they would tolerate on their heads. Neckband 1805 may also have a larger surface area over which to diffuse and disperse heat to the ambient environment. Thus, neckband 1805 may allow for greater battery and computation capacity than might otherwise have been possible on a stand-alone eyewear device. Since weight carried in neckband 1805 may be less invasive to a user than weight carried in eyewear device 1802, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 1805 may be communicatively coupled with eyewear device 1802 and/or to other devices. These other devices may provide certain functions (e.g., tracking, localizing, depth mapping, processing, storage, etc.) to augmented-reality system 1800. In the embodiment of FIG. 18, neckband 1805 may include two acoustic transducers (e.g., 1820(1) and 1820(J)) that are part of the microphone array (or potentially form their own microphone subarray). Neckband 1805 may also include a controller 1825 and a power source 1835.

Acoustic transducers 1820(1) and 1820(J) of neckband 1805 may be configured to detect sound and convert the detected sound into an electronic format (analog or digital). In the embodiment of FIG. 18, acoustic transducers 1820(1) and 1820(J) may be positioned on neckband 1805, thereby increasing the distance between the neckband acoustic transducers 1820(1) and 1820(J) and other acoustic transducers 1820 positioned on eyewear device 1802. In some cases, increasing the distance between acoustic transducers 1820 of the microphone array may improve the accuracy of beamforming performed via the microphone array. For example, if a sound is detected by acoustic transducers 1820(C) and 1820(D) and the distance between acoustic transducers 1820(C) and 1820(D) is greater than, for example, the distance between acoustic transducers 1820(D) and 1820(E), the determined source location of the detected sound may be more accurate than if the sound had been detected by acoustic transducers 1820(D) and 1820(E).

Controller 1825 of neckband 1805 may process information generated by the sensors on neckband 1805 and/or augmented-reality system 1800. For example, controller 1825 may process information from the microphone array that describes sounds detected by the microphone array. For each detected sound, controller 1825 may perform a direction-of-arrival (DOA) estimation to estimate a direction from which the detected sound arrived at the microphone array. As the microphone array detects sounds, controller 1825 may populate an audio data set with the information. In embodiments in which augmented-reality system 1800 includes an inertial measurement unit, controller 1825 may compute all inertial and spatial calculations from the IMU located on eyewear device 1802. A connector may convey information between augmented-reality system 1800 and neckband 1805 and between augmented-reality system 1800 and controller 1825. The information may be in the form of optical data, electrical data, wireless data, or any other transmittable data form. Moving the processing of information generated by augmented-reality system 1800 to neckband 1805 may reduce weight and heat in eyewear device 1802, making it more comfortable to the user.

Power source 1835 in neckband 1805 may provide power to eyewear device 1802 and/or to neckband 1805. Power source 1835 may include, without limitation, lithium ion batteries, lithium-polymer batteries, primary lithium batteries, alkaline batteries, or any other form of power storage. In some cases, power source 1835 may be a wired power source. Including power source 1835 on neckband 1805 instead of on eyewear device 1802 may help better distribute the weight and heat generated by power source 1835.

As noted, some artificial reality systems may, instead of blending an artificial reality with actual reality, substantially replace one or more of a user's sensory perceptions of the real world with a virtual experience. One example of this type of system is a head-worn display system, such as virtual-reality system 1900 in FIG. 19, that mostly or completely covers a user's field of view. Virtual-reality system 1900 may include a front rigid body 1902 and a band 1904 shaped to fit around a user's head. Virtual-reality system 1900 may also include output audio transducers 1906(A) and 1906(B). Furthermore, while not shown in FIG. 19, front rigid body 1902 may include one or more electronic elements, including one or more electronic displays, one or more inertial measurement units (IMUS), one or more tracking emitters or detectors, and/or any other suitable device or system for creating an artificial-reality experience.

Artificial reality systems may include a variety of types of visual feedback mechanisms. For example, display devices in augmented-reality system 1800 and/or virtual-reality system 1900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial reality systems may include a single display screen for both eyes or may provide a display screen for each eye, which may allow for additional flexibility for varifocal adjustments or for correcting a user's refractive error. Some of these artificial reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial reality systems described herein may include one or more projection systems. For example, display devices in augmented-reality system 1800 and/or virtual-reality system 1900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial reality systems may also be configured with any other suitable type or form of image projection system, such as retinal projectors used in virtual retina displays.

The artificial reality systems described herein may also include various types of computer vision components and subsystems. For example, augmented-reality system 1800 and/or virtual-reality system 1900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

The artificial reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial reality experience in one or more of these contexts and environments and/or in other contexts and environments.

Eye-Tracking System

In some embodiments, the systems described herein may also include an eye-tracking subsystem (that may also be referred to as an eye tracker) designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

FIG. 20 is an illustration of an exemplary system 2000 that incorporates an eye-tracking subsystem capable of tracking a user's eye(s). As depicted in FIG. 20, system 2000 may include a light source 2002, an optical subsystem 2004, an eye-tracking subsystem 2006, and/or a control subsystem 2008. In some examples, light source 2002 may generate light for an image (e.g., to be presented to an eye 2001 of the viewer). Light source 2002 may represent any of a variety of suitable devices. For example, light source 2002 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 2004 may receive the light generated by light source 2002 and generate, based on the received light, converging light 2020 that includes the image. In some examples, optical subsystem 2004 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 2020. Further, various mechanical couplings may serve to maintain the relative spacing and/or the orientation of the optical components in any suitable combination.

In one embodiment, eye-tracking subsystem 2006 may generate tracking information indicating a gaze angle of an eye 2001 of the viewer. In this embodiment, control subsystem 2008 may control aspects of optical subsystem 2004 (e.g., the angle of incidence of converging light 2020) based at least in part on this tracking information. Additionally, in some examples, control subsystem 2008 may store and utilize historical tracking information (e.g., a history of the tracking information over a given duration, such as the previous second or fraction thereof) to anticipate the gaze angle of eye 2001 (e.g., an angle between the visual axis and the anatomical axis of eye 2001). In some embodiments, eye-tracking subsystem 2006 may detect radiation emanating from some portion of eye 2001 (e.g., the cornea, the iris, the pupil, or the like) to determine the current gaze angle of eye 2001. In other examples, eye-tracking subsystem 2006 may employ a wavefront sensor to track the current location of the pupil.

Any number of techniques can be used to track eye 2001. Some techniques may involve illuminating eye 2001 with infrared light and measuring reflections with at least one optical sensor that is tuned to be sensitive to the infrared light. Information about how the infrared light is reflected from eye 2001 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 2006 may be digitized (i.e., converted to an electronic signal). Further, the sensor may transmit a digital representation of this electronic signal to one or more processors (e.g., processors associated with a device including eye-tracking subsystem 2006). Eye-tracking subsystem 2006 may include any of a variety of sensors in a variety of different configurations. For example, eye-tracking subsystem 2006 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 2006 to track the movement of eye 2001. In another example, these processors may track the movements of eye 2001 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 2006 may be programmed to use an output of the sensor(s) to track movement of eye 2001. In some embodiments, eye-tracking subsystem 2006 may analyze the digital representation generated by the sensors to extract eye rotation information from changes in reflections. In one embodiment, eye-tracking subsystem 2006 may use corneal reflections or glints (also known as Purkinje images) and/or the center of the eye's pupil 2022 as features to track over time.

In some embodiments, eye-tracking subsystem 2006 may use the center of the eye's pupil 2022 and infrared or near-infrared, non-collimated light to create corneal reflections. In these embodiments, eye-tracking subsystem 2006 may use the vector between the center of the eye's pupil 2022 and the corneal reflections to compute the gaze direction of eye 2001. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 2006 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 2001 may act as a retroreflector as the light reflects off the retina, thereby creating a bright pupil effect similar to a red-eye effect in photography. If the illumination source is offset from the optical path, then the eye's pupil 2022 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 2008 may control light source 2002 and/or optical subsystem 2004 to reduce optical aberrations (e.g., chromatic aberrations and/or monochromatic aberrations) of the image that may be caused by or influenced by eye 2001. In some examples, as mentioned above, control subsystem 2008 may use the tracking information from eye-tracking subsystem 2006 to perform such control. For example, in controlling light source 2002, control subsystem 2008 may alter the light generated by light source 2002 (e.g., by way of image rendering) to modify (e.g., pre-distort) the image so that the aberration of the image caused by eye 2001 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

FIG. 21A is a more detailed illustration of various aspects of the eye-tracking subsystem illustrated in FIG. 20. As shown in this figure, an eye-tracking subsystem 2100 may include at least one source 2104 and at least one sensor 2106. Source 2104 generally represents any type or form of element capable of emitting radiation. In one example, source 2104 may generate visible, infrared, and/or near-infrared radiation. In some examples, source 2104 may radiate non-collimated infrared and/or near-infrared portions of the electromagnetic spectrum towards an eye 2102 of a user. Source 2104 may utilize a variety of sampling rates and speeds. For example, the disclosed systems may use sources with higher sampling rates in order to capture fixational eye movements of a user's eye 2102 and/or to correctly measure saccade dynamics of the user's eye 2102. As noted above, any type or form of eye-tracking technique may be used to track the user's eye 2102, including optical-based eye-tracking techniques, ultrasound-based eye-tracking techniques, etc.

Sensor 2106 generally represents any type or form of element capable of detecting radiation, such as radiation reflected off the user's eye 2102. Examples of sensor 2106 include, without limitation, a charge coupled device (CCD), a photodiode array, a complementary metal-oxide-semiconductor (CMOS) based sensor device, and/or the like. In one example, sensor 2106 may represent a sensor having predetermined parameters, including, but not limited to, a dynamic resolution range, linearity, and/or other characteristic selected and/or designed specifically for eye tracking.

As detailed above, eye-tracking subsystem 2100 may generate one or more glints. As detailed above, a glint 2103 may represent reflections of radiation (e.g., infrared radiation from an infrared source, such as source 2104) from the structure of the user's eye. In various embodiments, glint 2103 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 21B shows an example image 2105 captured by an eye-tracking subsystem, such as eye-tracking subsystem 2100. In this example, image 2105 may include both the user's pupil 2108 and a glint 2110 near the same. In some examples, pupil 2108 and/or glint 2110 may be identified using an artificial-intelligence-based algorithm, such as a computer-vision-based algorithm. In one embodiment, image 2105 may represent a single frame in a series of frames that may be analyzed continuously in order to track the eye 2102 of the user. Further, pupil 2108 and/or glint 2110 may be tracked over a period of time to determine a user's gaze.

In one example, eye-tracking subsystem 2100 may be configured to identify and measure the inter-pupillary distance (IPD) of a user. In some embodiments, eye-tracking subsystem 2100 may measure and/or calculate the IPD of the user while the user is wearing the artificial reality system. In these embodiments, eye-tracking subsystem 2100 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 2000 and/or eye-tracking subsystem 2100 may be incorporated into augmented-reality system 1800 in FIG. 18 and/or virtual-reality system 1900 in FIG. 19 to enable these systems to perform various eye-tracking tasks (including one or more of the eye-tracking operations described herein).

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed (e.g., eye-tracking sensor data), transform the data (e.g., into one or more of gaze direction, object viewed, or other vision-related parameter), output a result of the transformation to perform a function (e.g., modify an augmented reality environment, modify a real environment, modify an operational parameter of a real or virtual device, provide a control signal to an apparatus such as an electronic device, vehicle, or other apparatus), use the result of the transformation to perform a function, and store the result of the transformation to perform a function (e.g., in a memory device). Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein may be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An apparatus comprising:
a display;
an optical configuration configured to provide an image of the display; and
a controller, wherein:
the optical configuration comprises a lens having a lens surface;
the lens surface supports an electrical component and at least one serpentine electrode; and
the controller is in electrical communication with the electrical component through the serpentine electrode.

2. The apparatus of claim 1, wherein the serpentine electrode has an approximately sinusoidal shape.

3. The apparatus of claim 1, wherein the serpentine electrode comprises at least one of a metal, a transparent conductive oxide, graphene, or an electrically conductive polymer.

4. The apparatus of claim 1, wherein:
the lens surface supports a first serpentine electrode and a second serpentine electrode;
the electrical component has a first terminal in electrical communication with the first serpentine electrode; and
the electrical component has a second terminal in electrical communication with the second serpentine electrode.

5. The apparatus of claim 1, wherein the apparatus is configured so that the image of the display is formed from light from the display that passes through the lens surface.

6. The apparatus of claim 1, wherein the electrical component comprises a light source.

7. The apparatus of claim 6, wherein the controller is configured to energize the light source using an electrical signal provided through the at least one serpentine electrode.

8. The apparatus of claim 6, wherein the light source comprises a laser.

9. The apparatus of claim 6, wherein:
the apparatus comprises an eye-tracking subsystem, the eye-tracking subsystem comprises the light source and a sensor; and
the sensor is configured to provide a sensor signal to the controller.

10. The apparatus of claim 9, wherein the controller is further configured to determine a gaze direction based on the sensor signal.

11. The apparatus of claim 1, wherein:
the lens is an adjustable lens comprising an elastic membrane; and
the serpentine electrode is supported by the elastic membrane.

12. The apparatus of claim 11, wherein:
the electrical component comprises an electroactive element; and
the controller is configured to adjust an optical power of the lens by providing an electrical signal to the electroactive element through the serpentine electrode.

13. The apparatus of claim 12, wherein:
the controller is configured to apply a control signal to the electroactive element, the control signal inducing an electrostriction in the electroactive element.

14. The apparatus of claim 12, wherein the electroactive element comprises an electroactive polymer layer disposed on the elastic membrane.

15. The apparatus of claim 1, wherein:
the image of the display is formed by light emitted by the display that passes through the lens surface.

16. The apparatus of claim 1, wherein:
the apparatus comprises a head-mounted device; and
the image of the display is viewable by a user of the apparatus when the user wears the head-mounted device.

17. The apparatus of claim 1, wherein the apparatus comprises an augmented reality device or a virtual reality device.

18. A method, comprising:
providing at least one serpentine electrode on a surface of a lens; and
locating a light source on the surface of the lens, the light source being in electrical communication with the at least one serpentine electrode.

19. The method of claim 18, wherein:
the light source comprises a laser; and
the serpentine electrode has a sinusoidally-shaped electrode portion.

20. A method comprising:
applying an electrical signal to an electroactive element located on an elastic membrane of an adjustable lens using at least one serpentine element supported by the elastic membrane to adjust an optical power of the adjustable lens,
wherein the electroactive element comprises an electro-strictive polymer layer disposed on the elastic membrane.
